(19) United States
(12) Patent Application Publication
(10) Pub. No.: US 2026/0287842 A1
(43) Pub. Date: Sep. 24, 2026

(54) OPTICAL CABLE MEMBER

(71) Applicants: SUMITOMO ELECTRIC INDUSTRIES, LTD., Osaka-shi, Osaka (JP); SUMITOMO ELECTRIC OPTIFRONTIER CO., LTD., Yokohama-shi, Kanagawa (JP)

(72) Inventors: Takayuki SHIMAZU, Osaka-shi (JP); Junji FUKUI, Yokohama-shi (JP)

(73) Assignees: SUMITOMO ELECTRIC INDUSTRIES, LTD., Osaka-shi, Osaka (JP); SUMITOMO ELECTRIC OPTIFRONTIER CO., LTD., Yokohama-shi, Kanagawa (JP)

(21) Appl. No.: 19/490,208

(22) PCT Filed: Jun. 7, 2024
(86) PCT No.: PCT/JP2024/020903

§ 371 Date: Dec. 4, 2025

(30) Foreign Application Priority Data
Jun. 9, 2023 (JP) 2023-095543

(51) Int. Cl. G02B 6/44; G02B 6/54

(52) U.S. Cl. CPC G02B 6/443; G02B 6/4435; G02B 6/54

(57) ABSTRACT

An optical cable member includes an optical cable including a plurality of optical fibers, at least one connector attached to tips of the plurality of optical fibers, and a sheath covering the plurality of optical fibers, a protective tube configured to accommodate the plurality of optical fibers exposed from the sheath, and the at least one connector, and a connection member that connects the optical cable and the protective tube. The protective tube has a tube shape having an uneven first inner surface at an end portion to which the connection member is attached.

### TECHNICAL FIELD

The present disclosure relates to an optical cable member.

This application claims priority based on Japanese Application No. 2023-095543 filed on Jun. 9, 2023, and incorporates by reference all of the contents of the above-mentioned Japanese application.

### BACKGROUND ART

Patent Literatures 1 to 3 disclose an optical cable to which a pulling portion is attached. A sheath is peeled off at a tip of the optical cable, and connectors are attached to tips of optical fibers exposed from the sheath. The pulling portion includes a protective tube for protecting the optical fibers to which the connectors are attached. The protective tube is attached to the optical cable in a state in which the optical fibers to which the connectors are attached are accommodated in the protective tube. After the optical cable is pulled by the pulling portion and the optical cable is laid, the protective tube is detached from the optical cable, and the optical fibers are spliced to other optical fibers or the like using the connectors.

### CITATION LIST

### Patent Literature

Patent Literature 1: JPS63-125903A

Patent Literature 2: U.S. Patent Application Publication No. 2022/0120988

Patent Literature 3: WO 2022/045139

### SUMMARY OF INVENTION

An optical cable member of the present disclosure includes:
an optical cable including a plurality of optical fibers, at least one connector attached to tips of the plurality of optical fibers, and a sheath covering the plurality of optical fibers;
a protective tube configured to accommodate the plurality of optical fibers exposed from the sheath, and the at least one connector; and
a connection member that connects the optical cable and the protective tube, in which
the protective tube has a tube shape having an uneven inner surface at an end portion to which the connection member is attached, and
the connection member includes:
   a first member including a first insertion portion configured to be inserted into the protective tube, and a first protruding portion configured to be engaged with a recess on the inner surface of the protective tube; and
   a second member including a second insertion portion configured to be inserted into the protective tube, and a second protruding portion configured to be engaged with the recess on the inner surface of the protective tube.

### BRIEF DESCRIPTION OF DRAWINGS

FIG. 1 is a diagram illustrating a configuration of an optical cable member according to a first embodiment of the present disclosure.

FIG. 2 is a cross-sectional view of a cross section of the optical cable member taken along a line II-II in FIG. 1, as viewed from a direction indicated by an arrow.

FIG. 3 is an exploded view of a connection member of the optical cable member of FIG. 1.

FIG. 4 is a view illustrating a first front connection portion or a second front connection portion of the connection member of FIG. 1.

FIG. 5 is a view illustrating the first front connection portion or the second front connection portion of the connection member of FIG. 1.

FIG. 6A is a diagram illustrating a connection method of an optical cable and a protective tube by the connection member of FIG. 1.

FIG. 6B is a diagram illustrating a connection method of the optical cable and the protective tube by the connection member of FIG. 1.

FIG. 6C is a diagram illustrating a connection method of the optical cable and the protective tube by the connection member of FIG. 1.

FIG. 6D is a diagram illustrating a connection method of the optical cable and the protective tube by the connection member of FIG. 1.

FIG. 6E is a diagram illustrating a connection method of the optical cable and the protective tube by the connection member of FIG. 1.

FIG. 7 is a diagram illustrating a configuration of an optical cable member according to a second embodiment of the present disclosure.

FIG. 8 is a diagram illustrating a first front connection portion of a connection member of FIG. 7.

FIG. 9 is a diagram illustrating the first front connection portion of the connection member of FIG. 7.

FIG. 10 is a diagram illustrating a second front connection portion of the connection member of FIG. 7.

FIG. 11A is a diagram illustrating a connection method of an optical cable and a protective tube by the connection member of FIG. 7.

FIG. 11B is a diagram illustrating a connection method of the optical cable and the protective tube by the connection member of FIG. 7.

FIG. 11C is a diagram illustrating a connection method of the optical cable and the protective tube by the connection member of FIG. 7.

FIG. 11D is a diagram illustrating a connection method of the optical cable and the protective tube by the connection member of FIG. 7.

FIG. 12 is a diagram illustrating a configuration of an optical cable member according to a third embodiment of the present disclosure.

FIG. 13 is a diagram illustrating a first front connection portion of a connection member of FIG. 12.

FIG. 14 is a diagram illustrating the first front connection portion of the connection member of FIG. 12.

FIG. 15 is a diagram illustrating a second front connection portion of the connection member of FIG. 12.

FIG. 16A is a diagram illustrating a connection method of an optical cable and a protective tube by the connection member of FIG. 12.

FIG. 16B is a diagram illustrating a connection method of the optical cable and the protective tube by the connection member of FIG. 12.

FIG. 16C is a diagram illustrating a connection method of the optical cable and the protective tube by the connection member of FIG. 12.

FIG. 17 is an exploded view illustrating a configuration of an optical cable member according to Modification 1.

FIG. 18 is a cross-sectional view of the optical cable member of FIG. 17.

FIG. 19 is a cross-sectional view illustrating a configuration of an optical cable member according to Modification 2.

FIG. 20 is a cross-sectional view illustrating a configuration of an optical cable member according to Modification 3.

FIG. 21 is a cross-sectional view illustrating a configuration of an optical cable member according to Modification 4.

FIG. 22 is an exploded view illustrating a configuration of a lid portion of a protective tube.

FIG. 23 is a cross-sectional view of the protective tube of FIG. 22.

FIG. 24A is a diagram illustrating a connection method of a lid portion and a body portion of the protective tube of FIG. 22.

FIG. 24B is a diagram illustrating a connection method of the lid portion and the body portion of the protective tube of FIG. 22.

FIG. 24C is a diagram illustrating a connection method of the lid portion and the body portion of the protective tube of FIG. 22.

FIG. 25 is a cross-sectional view illustrating a configuration of the optical cable member used in a cable pulling method.

### DESCRIPTION OF EMBODIMENTS

### Technical Problem

When an optical cable is laid in an underground pipeline, an outer diameter of a portion at which a protective tube is connected to the optical cable becomes larger, and it may be difficult to pass the optical cable through the underground pipeline. In addition, from the viewpoint of work efficiency, it is required that the protective tube be easily detachable from the optical cable.

An object of the present disclosure is to provide an optical cable member in which an optical cable is easily laid and a protective tube can be easily detached from the optical cable after the optical cable is laid.

### Advantageous Effects of Present Disclosure

According to the present disclosure, it is possible to provide the optical cable member in which the optical cable is easily laid, and the protective tube can be easily detached from the optical cable after the optical cable is laid.

### Description of Embodiments of Present Disclosure

First, contents of an embodiment of the present disclosure will be listed and described.

(1) An optical cable member of the present disclosure includes:
an optical cable including a plurality of optical fibers, at least one connector attached to tips of the plurality of optical fibers, and a sheath covering the plurality of optical fibers;
a protective tube configured to accommodate the plurality of optical fibers exposed from the sheath, and the at least one connector; and
a connection member that connects the optical cable and the protective tube, in which
the protective tube has a tube shape having an uneven inner surface at an end portion to which the connection member is attached, and
the connection member includes:
   a first member including a first insertion portion configured to be inserted into the protective tube, and a first protruding portion configured to be engaged with a recess on the inner surface of the protective tube; and
   a second member including a second insertion portion configured to be inserted into the protective tube, and a second protruding portion configured to be engaged with the recess on the inner surface of the protective tube.

According to the above configuration, the first member and the second member can be easily attached to the protective tube, respectively, by inserting the insertion portion into the protective tube and hooking the protruding portion in the recess on the inner surface of the protective tube to engage the protruding portion with the recess. In addition, after the optical cable is laid, the first member and the second member can be easily detached from the protective tube, respectively, by detaching the protruding portion from the recess on the inner surface of the protective tube to release the engagement with the recess.

In addition, the first member and the second member are attached to the inside of the protective tube, respectively, and thus the connection member can be configured not to be larger than the protective tube.

As described above, it is possible to provide the optical cable member in which the optical cable is easily laid, and the protective tube can be easily detached from the optical cable after the optical cable is laid.

(2) According to (1),
the connection member may include a third member attached to the sheath of the optical cable, and
the third member may be fixed to at least the first member.

According to the above configuration, in the connection member, a portion attached to the sheath of the optical cable and a portion attached to the protective tube are formed by different members, and thus a degree of freedom in design of each member can be increased.

(3) According to (2),
the first member may include a first fixing portion fixed to the third member, and the first fixing portion is formed with a first hole penetrating the first fixing portion,
the second member may include a second fixing portion fixed to the third member, and the second fixing portion is formed with a second hole penetrating the second fixing portion,
the third member may include a third fixing portion fixed to the first member and the second member, the third fixing portion is formed with a third hole penetrating the third fixing portion at a position corresponding to the first hole, and the third fixing portion is formed with a fourth hole penetrating the third fixing portion at a position corresponding to the second hole, and
the connection member may include a first screw member configured to be inserted into the first hole and the third hole, and a second screw member configured to be inserted into the second hole and the fourth hole.

According to the above configuration, the first member and the second member can be detachably fixed to the third member by the screw member.

(4) According to (2),
the first member may include a first fixing portion configured to be fixed to the third member,
the third member may include a third fixing portion configured to be fixed to the first member,
one of the first fixing portion or the third fixing portion may have an outer peripheral surface on which a male screw portion is formed, and
another of the first fixing portion or the third fixing portion, which is not formed with the male screw portion on the outer peripheral surface thereof, may have an inner peripheral surface on which a female screw portion to be screwed onto the male screw portion is formed.

According to the above configuration, by screwing one of the first member and the third member into the other of the first member and the third member, the first member and the third member can be detachably fixed without a tool.

(5) According to (2),
the first member may include a first fixing portion configured to be fixed to the third member,
the third member may include a third fixing portion configured to be fixed to the first member,
one of the first fixing portion or the third fixing portion may be formed with an L-shaped hole, and
another of the first fixing portion or the third fixing portion in which no L-shaped hole is formed may include a protrusion portion that is configured to be engaged with the L-shaped hole.

According to the above configuration, by inserting one of the first member and the third member into the other of the first member and the third member and rotating them, the first member and the third member can be detachably fixed without a tool.

(6) According to any one of (2) to (5), the first member and the second member may be fixed to each other by an adhesive.

According to the above configuration, the first member and the second member can be firmly fixed to each other.

(7) According to any one of (2) to (6), the third member may be fixed to the sheath of the optical cable by an adhesive.

According to the above configuration, the third member can be firmly fixed to the sheath of the optical cable.

(8) According to any one of (2) to (7),
the third member may be formed with a fifth hole penetrating the third member, and
the optical cable member may include a screw member that is inserted into the fifth hole and brought into contact with the sheath of the optical cable.

According to the above configuration, the third member can be detachably fixed to the sheath of the optical cable by the screw member.

(9) According to (7) or (8), the third member may include a first portion and a second portion that are dividable in a radial direction of the optical cable.

According to the above configuration, the third member can also be fixed to the optical cable after the optical fibers and the connector are inserted into the protective tube, and thus a degree of freedom in attachment workability of the third member is increased.

(10) According to any one of (1) to (9),
the protective tube may include a lid portion and a body portion accommodating the at least one connector and the plurality of optical fibers exposed from the sheath,
the body portion may include a first end portion to which the connection member is attached, and a second end portion to which the lid portion is fixed,
the body portion may have a tube shape having an uneven inner surface at the first end portion and the second end portion, and
the lid portion may include:
a first member including a first insertion portion configured to be inserted into the body portion, and a first protruding portion configured to be engaged with a recess on the inner surface of the body portion; and
a second member including a second insertion portion configured to be inserted into the body portion, and a second protruding portion configured to be engaged with the recess on the inner surface of the body portion.

According to the above configuration, the lid portion can be detachably fixed to the body portion by inserting the respective insertion portions of the first member and the second member into the body portion and hooking the protruding portion in the recess on the inner surface of the body portion to engage the protruding portion with the recess.

### Details of Embodiments of Present Disclosure

A specific example of an optical cable member according to an embodiment of the present disclosure will be described below with reference to the drawings. The present invention is not limited to these exemplifications, but is indicated by the scope of claims, and is intended to include all modifications within a scope and meaning equivalent to the scope of claims. In addition, in each drawing used in the following description, the scale is appropriately changed so that each member can be made recognizable.

In the drawings, an arrow U indicates an upward direction of an illustrated structure. An arrow D indicates a downward direction of the illustrated structure. An arrow F indicates a forward direction of the illustrated structure. An arrow B indicates a rearward direction of the illustrated structure. An arrow R indicates a rightward direction of the illustrated structure. An arrow L indicates a leftward direction of the illustrated structure. These directions are used for convenience in order to facilitate understanding of the exemplified configuration, and there is no intention to limit the directions or postures of the configuration during actual use.

### First Embodiment

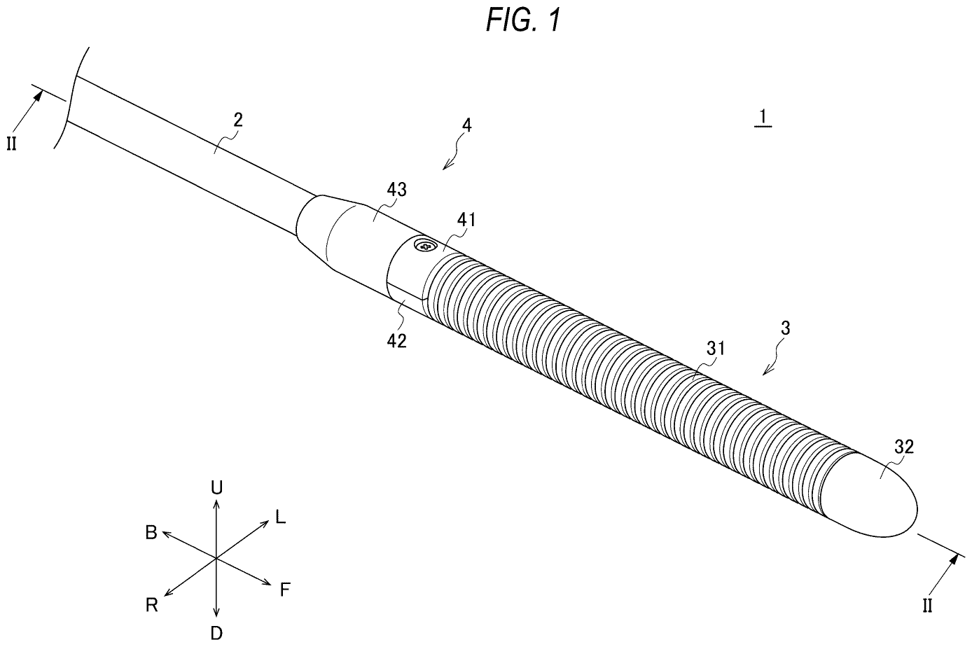

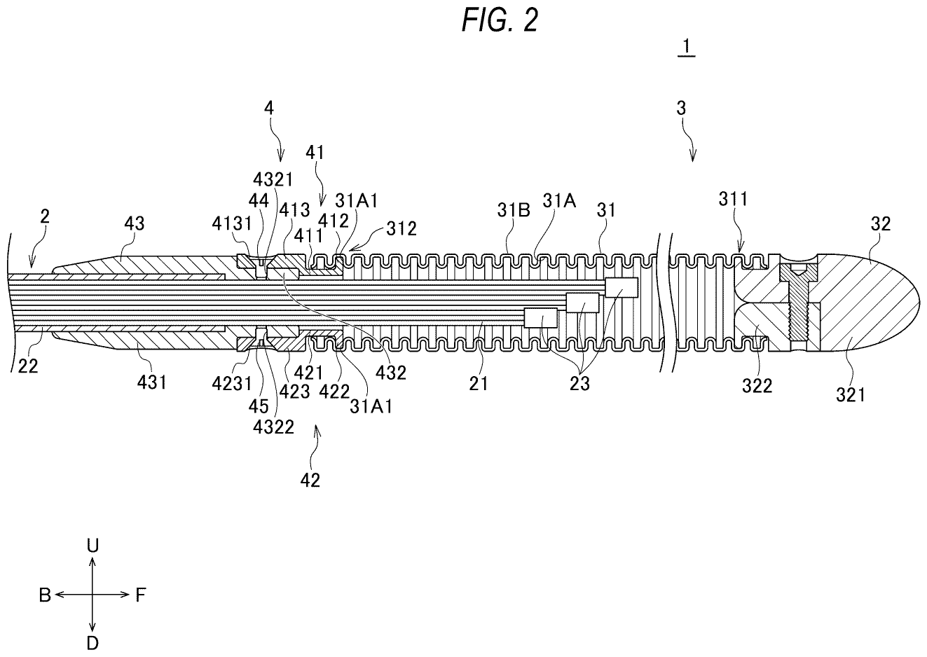

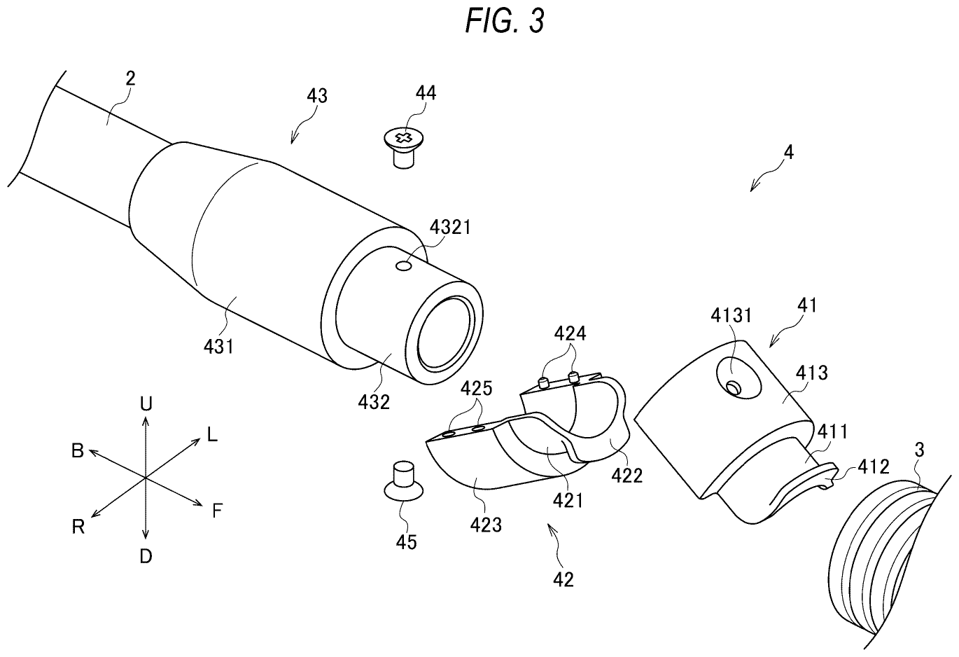

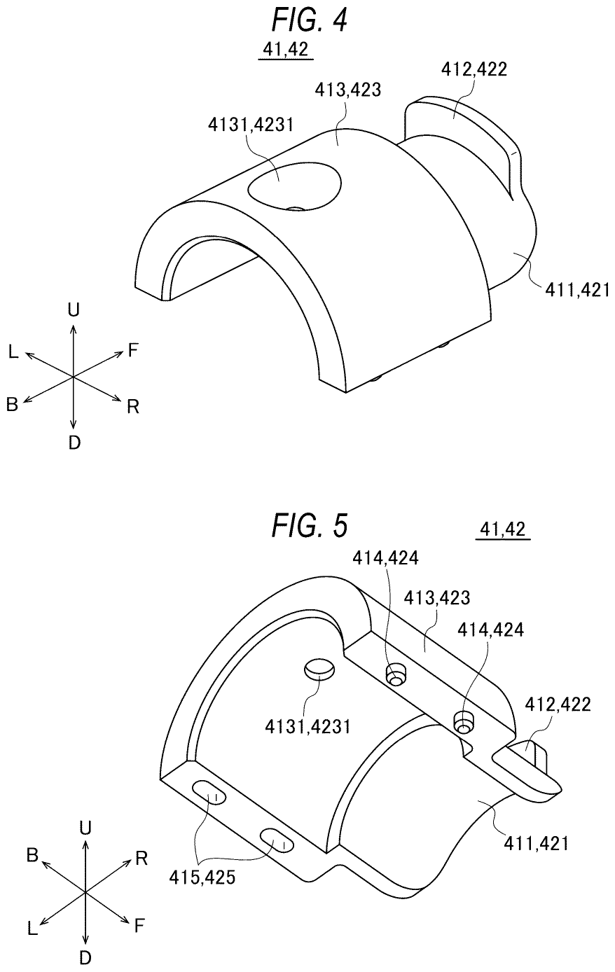

FIG. 1 illustrates a configuration example of an optical cable member 1 according to a first embodiment of the present disclosure. FIG. 2 is a cross-sectional view of the optical cable member 1 of FIG. 1. FIG. 3 illustrates an exploded view of a connection member 4 of the optical cable member 1 of FIG. 1. FIGS. 4 and 5 illustrate a configuration example of a first front connection portion 41 or a second front connection portion 42 of the connection member 4 of FIG. 1. In the present example, the first front connection portion 41 and the second front connection portion 42 have the same shape, and thus both will be described with reference to FIGS. 4 and 5.

As illustrated in FIG. 1, the optical cable member 1 includes an optical cable 2, a protective tube 3, and a connection member 4. The optical cable member 1 is a member for laying the optical cable 2 by using, for example, an air pressure feeding method. Specifically, the optical cable member 1 is used to insert the optical cable 2 into an air pressure feeding microduct, push the optical cable 2 while feeding high-pressure compressed air into the duct, and lay the optical cable 2 to a predetermined position. After the optical cable 2 is laid, the protective tube 3 is detached from the optical cable 2.

As illustrated in FIG. 2, the optical cable 2 includes a plurality of optical fibers 21, a sheath 22, and a plurality of connectors 23. The optical fiber 21 is formed by, for example, a glass fiber including a core and a cladding, and a coating layer with which an outer periphery of the glass fiber is coated. The sheath 22 is provided to cover the plurality of optical fibers 21. The plurality of optical fibers 21 are accommodated in the sheath 22 in a form of, for example, an optical fiber ribbon coupled in a single-core state or in a state of being arranged in parallel. The connectors 23 are attached to tips of one or more optical fibers 21. The number of optical fibers 21 and the number of connectors 23 are not limited to those illustrated in FIG. 2. The optical cable 2 may further include a tension member, a water absorbing tape, and the like.

The protective tube 3 accommodates the plurality of optical fibers 21 exposed from the sheath 22 and the plurality of connectors 23. The protective tube 3 is formed of, for example, metal or resin. The protective tube 3 includes a body portion 31 and a lid portion 32.

The body portion 31 extends along a longitudinal direction of the optical cable 2, and accommodates the plurality of optical fibers 21 exposed from the sheath 22 and the plurality of connectors 23. The lid portion 32 is fixed to a front end portion 311 of the body portion 31. The connection member 4 is attached to a rear end portion 312 of the body portion 31. The body portion 31 has a tube shape having an uneven inner surface 31A at least at the rear end portion 312. In the present example, the body portion 31 has a tube shape having the uneven inner surface 31A and an uneven outer surface 31B over the entire length in the longitudinal direction. In other words, in the present example, the body portion 31 has a bellows tube shape over the entire length in the longitudinal direction. The front end portion 311 is an example of a second end portion. The rear end portion 312 is an example of a first end portion.

The lid portion 32 is attached to the front end portion 311 of the body portion 31. The lid portion 32 includes a tip portion 321 and an attachment portion 322. The tip portion 321 has a curved shape such as a sphere, a half football, or a bell shape. The tip portion 321 has an outer diameter equal to or smaller than an outer diameter of the body portion 31, for example. The attachment portion 322 is disposed inside the front end portion 311 of the body portion 31 and is attached to the inner surface 31A of the front end portion 311 of the body portion 31.

The connection member 4 connects the optical cable 2 and the protective tube 3.

The connection member 4 is formed of metal or resin. In the present example, the connection member 4 includes the first front connection portion 41, the second front connection portion 42, and a rear connection portion 43. The first front connection portion 41 and the second front connection portion 42 are attached to the rear end portion 312 of the body portion 31 of the protective tube 3, respectively. The rear connection portion 43 is attached to the sheath 22 of the optical cable 2. In addition, the rear connection portion 43 is fixed to the first front connection portion 41 and the second front connection portion 42. The first front connection portion 41 is an example of a first member. The second front connection portion 42 is an example of a second member. The rear connection portion 43 is an example of a third member.

As illustrated in FIGS. 2 to 5, the first front connection portion 41 includes a first insertion portion 411 and a first protruding portion 412. The first insertion portion 411 is configured to be inserted into the rear end portion 312 of the protective tube 3. In the present example, the first insertion portion 411 has a semi-cylindrical shape extending along a longitudinal direction (front-rear direction in the present example) of the protective tube 3.

The first protruding portion 412 is configured to be engaged with a recess 31A1 on the inner surface 31A of the protective tube 3. In the present example, the first protruding portion 412 extends from a front end of the first insertion portion 411 along a surface orthogonal to the longitudinal direction of the protective tube 3.

The first front connection portion 41 includes a first fixing portion 413. The first front connection portion 41 is fixed to the rear connection portion 43 by the first fixing portion 413. In the present example, the first fixing portion 413 has a semi-cylindrical shape having an outer diameter larger than an outer diameter of the first insertion portion 411, and extends from a rear end of the first insertion portion 411 along the longitudinal direction of the protective tube 3. The first fixing portion 413 is formed with a first through hole 4131 penetrating the first fixing portion 413. The first through hole 4131 extends in a direction (up-down direction in the present example) orthogonal to the longitudinal direction of the protective tube 3. The first through hole 4131 is an example of a first hole.

As illustrated in FIG. 5, the first front connection portion 41 includes a first protrusion 414 and a first positioning recess 415. The first protrusion 414 extends in a direction (up-down direction in the present example) facing the second front connection portion 42. The first positioning recess 415 is recessed in the direction facing the second front connection portion 42.

The second front connection portion 42 includes a second insertion portion 421 and a second protruding portion 422. In the present example, the second front connection portion 42 has the same shape as the first front connection portion 41. The second insertion portion 421 is configured to be inserted into the protective tube 3. In the present example, the second insertion portion 421 has a semi-cylindrical shape extending along the longitudinal direction of the protective tube 3. The second protruding portion 422 is configured to be engaged with the recess on the inner surface 31A of the protective tube 3. In the present example, the second protruding portion 422 extends from a front end of the second insertion portion 421 along the surface orthogonal to the longitudinal direction of the protective tube 3.

The second front connection portion 42 includes a second fixing portion 423. The second front connection portion 42 is fixed to the rear connection portion 43 by the second fixing portion 423. In the present example, the second fixing portion 423 has a semi-cylindrical shape having an outer diameter larger than an outer diameter of the second insertion portion 421, and extends from a rear end of the second insertion portion 421 along the longitudinal direction of the protective tube 3. The second fixing portion 423 is formed with a second through hole 4231 penetrating the second fixing portion 423. The second through hole 4231 extends in the direction (up-down direction in the present example) orthogonal to the longitudinal direction of the protective tube 3. The second through hole 4231 is an example of a second hole.

As illustrated in FIG. 5, the second front connection portion 42 includes a second protrusion 424 and a second positioning recess 425. The second protrusion 424 extends in a direction (up-down direction in the present example) facing the first front connection portion 41. The second positioning recess 425 is recessed in the direction facing the first front connection portion 41. The second protrusion 424 is inserted into the first positioning recess 415 of the first front connection portion 41. The first protrusion 414 of the first front connection portion 41 is inserted into the second positioning recess 425. Accordingly, the second front connection portion 42 is positioned with respect to the first front connection portion 41.

As illustrated in FIGS. 2 and 3, the rear connection portion 43 includes a cable fixing portion 431. The cable fixing portion 431 is configured to be fixed to the sheath 22 of the optical cable 2. In the present example, the cable fixing portion 431 has a cylindrical shape, and the optical cable 2 including the sheath 22 is inserted therein. The cable fixing portion 431 is fixed to the sheath 22 of the optical cable 2 by, for example, an adhesive.

The rear connection portion 43 includes a connection portion fixing portion 432. The rear connection portion 43 is fixed to the first front connection portion 41 and the second front connection portion 42 by the connection portion fixing portion 432. In the present example, the connection portion fixing portion 432 has a cylindrical shape, and the optical fibers 21 exposed from the sheath 22 are inserted therein. In the present example, the connection portion fixing portion 432 has an outer diameter smaller than an outer diameter of the first fixing portion 413 of the first front connection portion 41 and an outer diameter of the second fixing portion 423 of the second front connection portion 42, and the first fixing portion 413 and the second fixing portion 423 are fixed to the outside of the connection portion fixing portion 432. The connection portion fixing portion 432 is formed with a through hole 4321 at a position corresponding to the first through hole 4131 of the first front connection portion 41. In addition, the connection portion fixing portion 432 is formed with a through hole 4322 at a position corresponding to the second through hole 4231 of the second front connection portion 42. The through hole 4321 and the through hole 4322 extend in the direction (up-down direction in the present example) orthogonal to the longitudinal direction of the protective tube 3. The connection portion fixing portion 432 is an example of a third fixing portion. The through hole 4321 is an example of a third hole. The through hole 4322 is an example of a fourth hole.

The connection member 4 further includes a first screw member 44 and a second screw member 45. The first front connection portion 41 is detachably fixed to the rear connection portion 43 by the first screw member 44. The second front connection portion 42 is detachably fixed to the rear connection portion 43 by the second screw member 45. Specifically, the first screw member 44 is inserted into the first through hole 4131 of the first front connection portion 41 and the through hole 4321 of the rear connection portion 43 in a state in which the first fixing portion 413 of the first front connection portion 41 is disposed outside the connection portion fixing portion 432 of the rear connection portion 43. Accordingly, the first fixing portion 413 of the first front connection portion 41 is fixed to the connection portion fixing portion 432 of the rear connection portion 43. In addition, the second screw member 45 is inserted into the second through hole 4231 of the second front connection portion 42 and the through hole 4322 of the rear connection portion 43 in a state in which the second fixing portion 423 of the second front connection portion 42 is disposed outside the connection portion fixing portion 432 of the rear connection portion 43. Accordingly, the second fixing portion 423 of the second front connection portion 42 is fixed to the connection portion fixing portion 432 of the rear connection portion 43.

### (Connection Method of Optical Cable 2 and Protective Tube 3)

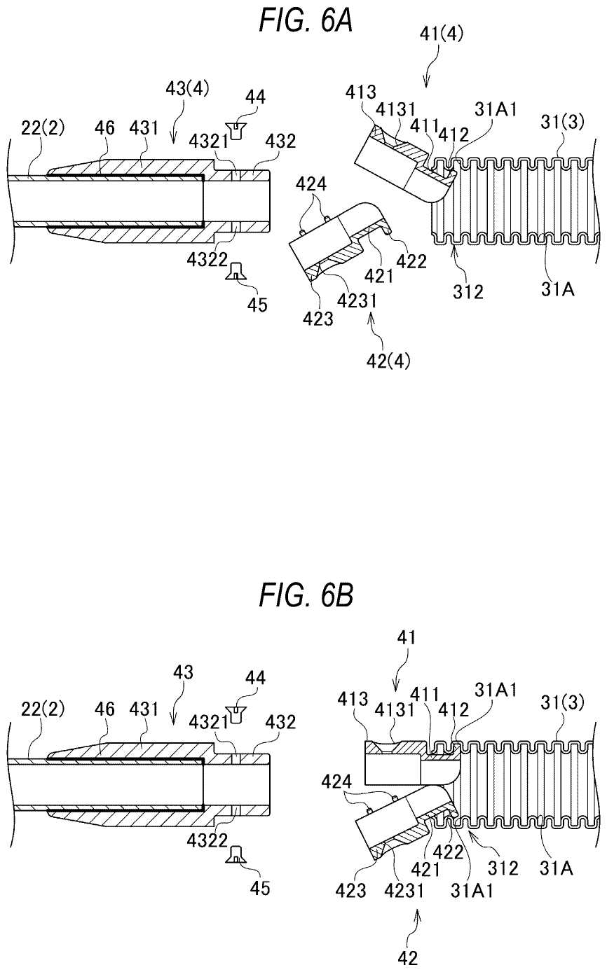

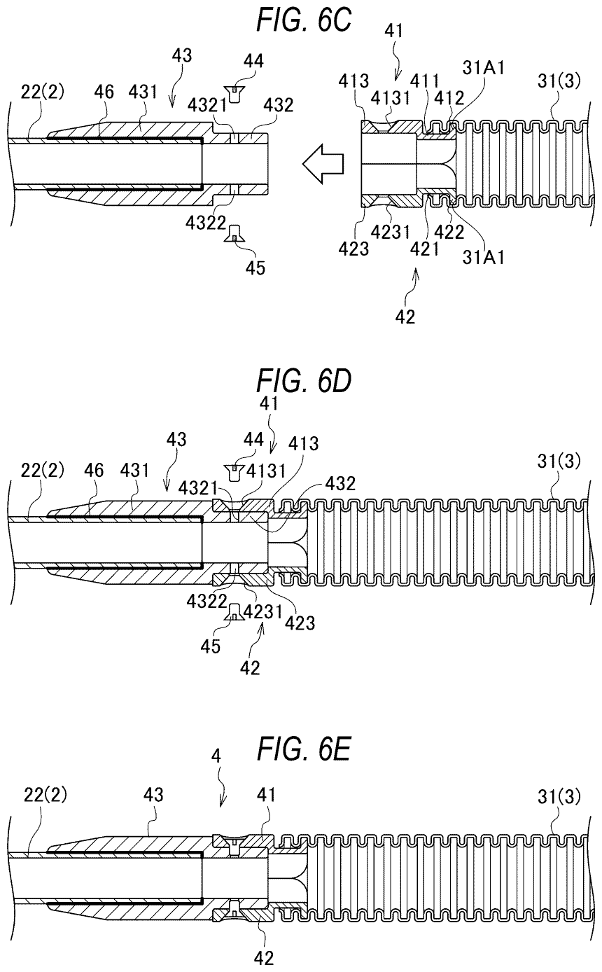

Next, a connection method of the optical cable 2 and the protective tube 3 by the connection member 4 will be described with reference to FIGS. 6A to 6E. In FIGS. 6A to 6E, the optical fibers 21 and the connectors 23 of the optical cable 2 are not illustrated.

First, the optical cable 2 subjected to a termination processing is prepared, and the rear connection portion 43 is attached to the sheath 22 of the optical cable 2 subjected to a termination processing. The termination processing is processing of detaching the sheath 22 at a front end portion of the optical cable 2 and attaching the connectors 23 to tip portions of the optical fibers 21 exposed from the sheath 22.

Specifically, the optical cable 2 subjected to a termination processing is passed through the rear connection portion 43. Then, as illustrated in FIG. 6A, the cable fixing portion 431 of the rear connection portion 43 is fixed to the sheath 22 of the optical cable 2 by the adhesive 46 in a state in which the optical fibers 21 exposed from the sheath 22 and the connectors 23 extend from a front end of the rear connection portion 43.

Subsequently, the first front connection portion 41 is attached to the protective tube 3. Specifically, as illustrated in FIG. 6A, the first insertion portion 411 and the first protruding portion 412 of the first front connection portion 41 are inserted into the rear end portion 312 of the protective tube 3, and the first protruding portion 412 is hooked and engaged with the recess 31A1 on the inner surface 31A of the rear end portion 312 of the protective tube 3 (see FIG. 6B).

Subsequently, the second front connection portion 42 is attached to the protective tube 3. Specifically, as illustrated in FIG. 6B, the second insertion portion 421 and the second protruding portion 422 of the second front connection portion 42 are inserted into the rear end portion 312 of the protective tube 3, and the second protruding portion 422 is hooked and engaged with the recess 31A1 on the inner surface 31A of the rear end portion 312 of the protective tube 3 (see FIG. 6C).

Then, the first protrusion 414 of the first front connection portion 41 is inserted into the second positioning recess 425 of the second front connection portion 42, and the second protrusion 424 of the second front connection portion 42 is inserted into the first positioning recess 415 of the first front connection portion 41. Accordingly, the second front connection portion 42 is positioned with respect to the first front connection portion 41.

Subsequently, the first front connection portion 41 and the second front connection portion 42 are fixed to the rear connection portion 43. Specifically, the optical fibers 21 exposed from the sheath 22 and the connectors 23 are inserted into the protective tube 3 through the inside of the first front connection portion 41 and the second front connection portion 42. Then, the first front connection portion 41 and the second front connection portion 42 are moved in a direction of an arrow illustrated in FIG. 6C, and the connection portion fixing portion 432 of the rear connection portion 43 is inserted into the first fixing portion 413 of the first front connection portion 41 and the second fixing portion 423 of the second front connection portion 42.

At this time, the first fixing portion 413, the second fixing portion 423, and the connection portion fixing portion 432 are positioned such that the first through hole 4131 of the first front connection portion 41 corresponds to the through hole 4321 of the rear connection portion 43, and the second through hole 4231 of the second front connection portion 42 corresponds to the through hole 4322 of the rear connection portion 43 (see FIG. 6D). For example, a front surface of the cable fixing portion 431 of the rear connection portion 43 is brought into contact with a rear surface of the first fixing portion 413 of the first front connection portion 41 and a rear surface of the second fixing portion 423 of the second front connection portion 42.

Subsequently, the first screw member 44 is inserted into the first through hole 4131 of the first front connection portion 41 and the through hole 4321 of the rear connection portion 43. In addition, the second screw member 45 is inserted into the second through hole 4231 of the second front connection portion 42 and the through hole 4322 of the rear connection portion 43. Accordingly, as illustrated in FIG. 6E, the optical cable 2 and the protective tube 3 are connected by the connection member 4.

On the other hand, after the optical cable 2 is laid, the first screw member 44 and the second screw member 45 are detached, and the first front connection portion 41 and the second front connection portion 42 are detached from the rear connection portion 43. Then, the first protruding portion 412 of the first front connection portion 41 is detached from the recess 31A1 on the inner surface 31A of the protective tube 3, and the first front connection portion 41 is detached from the protective tube 3. Similarly, the second protruding portion 422 is detached from the recess 31A1 on the inner surface 31A of the protective tube 3, and the second front connection portion 42 is detached from the protective tube 3. Accordingly, the protective tube 3 can be detached from the optical cable 2.

According to the optical cable member 1 according to the first embodiment of the present disclosure, the first insertion portion 411 is inserted into the protective tube 3, and the first protruding portion 412 is hooked on the recess 31A1 on the inner surface 31A of the protective tube 3 and engaged with the recess 31A1, so that the first front connection portion 41 can be easily attached to the protective tube 3. In addition, the first insertion portion 411 and the first protruding portion 412, which are portions connected to the protective tube 3, are attached to the inside of the protective tube 3, and thus the first front connection portion 41 can be configured not to be larger than the protective tube 3.

Similarly, the second insertion portion 421 is inserted into the protective tube 3, and the second protruding portion 422 is hooked on the recess 31A1 on the inner surface 31A of the protective tube 3 and engaged with the recess 31A1, so that the second front connection portion 42 can be easily attached to the protective tube 3. In addition, the second insertion portion 421 and the second protruding portion 422, which are portions connected to the protective tube 3, are attached to the inside of the protective tube 3, and thus the second front connection portion 42 can be configured not to be larger than the protective tube 3.

After the optical cable 2 is laid, the first protruding portion 412 is detached from the recess 31A1 on the inner surface 31A of the protective tube 3 to release the engagement with the recess 31A1, so that the first front connection portion 41 can be easily detached from the protective tube 3. Similarly, the second protruding portion 422 is detached from the recess 31A1 on the inner surface 31A of the protective tube 3 to release the engagement with the recess 31A1, so that the second front connection portion 42 can be easily detached from the protective tube 3.

Therefore, it is possible to provide the optical cable member 1 in which the optical cable 2 is easily laid and the protective tube 3 can be easily detached from the optical cable 2 after the optical cable 2 is laid.

In the present embodiment, the connection member 4 is attached to the sheath 22 of the optical cable 2 by the rear connection portion 43. In this way, in the connection member 4, a portion attached to the sheath 22 of the optical cable 2 and a portion attached to the protective tube 3 are formed by different members, and thus a degree of freedom in design of each member can be increased.

Further, in the present embodiment, the first front connection portion 41 and the second front connection portion 42 are fixed to the rear connection portion 43 by the first screw member 44 and the second screw member 45, and thus can be detachably fixed to the rear connection portion 43.

In the present embodiment, the rear connection portion 43 is fixed to the sheath 22 of the optical cable 2 by the adhesive 46, and thus the rear connection portion 43 can be firmly fixed to the sheath 22 of the optical cable 2.

Further, in the present embodiment, the first front connection portion 41 and the second front connection portion 42 are not bonded to each other and can be easily disassembled, and thus can be reused after being detached from the protective tube 3.

The first front connection portion 41 and the second front connection portion 42 may be further fixed to each other by an adhesive. The first front connection portion 41 and the second front connection portion 42 can be firmly fixed to each other by being bonded with an adhesive.

In the present embodiment, the portion of the connection member 4 attached to the protective tube 3 is formed by two members (the first front connection portion 41 and the second front connection portion 42), but may be formed by three or more members.

### Second Embodiment

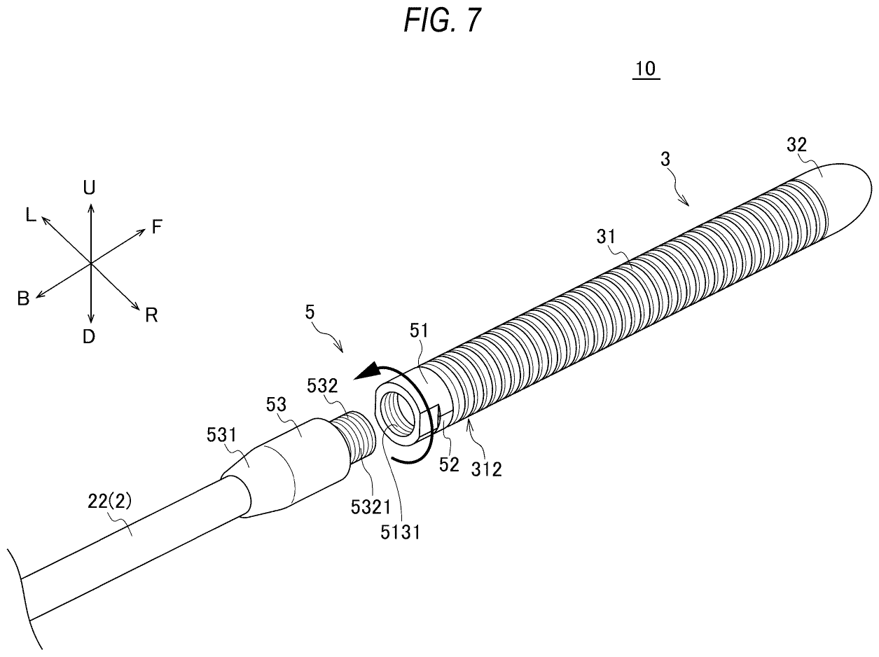

FIG. 7 illustrates a configuration example of an optical cable member 10 according to a second embodiment of the present disclosure. Members having the same reference numerals as those members already described in the description of the first embodiment will not be described for convenience of description.

The optical cable member 10 according to the second embodiment of the present disclosure is different from the optical cable member 1 according to the first embodiment in a structure for fixing a first front connection portion 51 and a second front connection portion 52 to a rear connection portion 53.

Specifically, as illustrated in FIG. 7, the optical cable member 10 includes a connection member 5 that connects the optical cable 2 and the protective tube 3. The connection member 5 is formed of metal or resin. The connection member 5 includes the first front connection portion 51, the second front connection portion 52, and the rear connection portion 53. The first front connection portion 51 and the second front connection portion 52 are attached to the rear end portion 312 of the body portion 31 of the protective tube 3, respectively. The rear connection portion 53 is attached to the sheath 22 of the optical cable 2. In addition, the rear connection portion 53 is fixed to the first front connection portion 51. The first front connection portion 51 is an example of a first member. The second front connection portion 52 is an example of a second member. The rear connection portion 53 is an example of a third member.

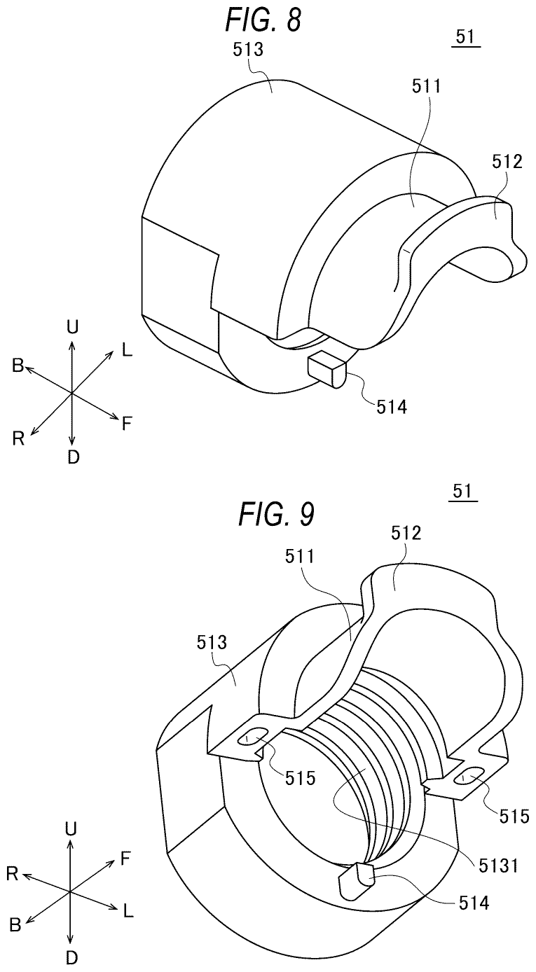

FIGS. 8 and 9 illustrate the first front connection portion 51. As illustrated in FIGS. 8 and 9, the first front connection portion 51 includes a first insertion portion 511 and a first protruding portion 512. The first insertion portion 511 is configured to be inserted into the rear end portion 312 of the protective tube 3. In the present example, the first insertion portion 511 has a semi-cylindrical shape extending along the longitudinal direction of the protective tube 3. The first protruding portion 512 is engaged with the recess 31A1 (see FIG. 2) on the inner surface 31A of the protective tube 3. In the present example, the first protruding portion 512 extends from a front end of the first insertion portion 511 along the surface orthogonal to the longitudinal direction of the protective tube 3.

The first front connection portion 51 includes a first fixing portion 513. The first front connection portion 51 is fixed to the rear connection portion 53 by the first fixing portion 513. In the present example, the first fixing portion 513 has a cylindrical shape having an outer diameter larger than an outer diameter of the first insertion portion 511, and extends from a rear end of the first insertion portion 511 along the longitudinal direction of the protective tube 3. The first fixing portion 513 is formed with a female screw portion 5131 on an inner peripheral surface thereof.

The first front connection portion 51 includes a first protrusion 514 and a first positioning recess 515. The first protrusion 514 extends along the longitudinal direction of the protective tube 3. The first positioning recess 515 is recessed in a direction facing the second front connection portion 52.

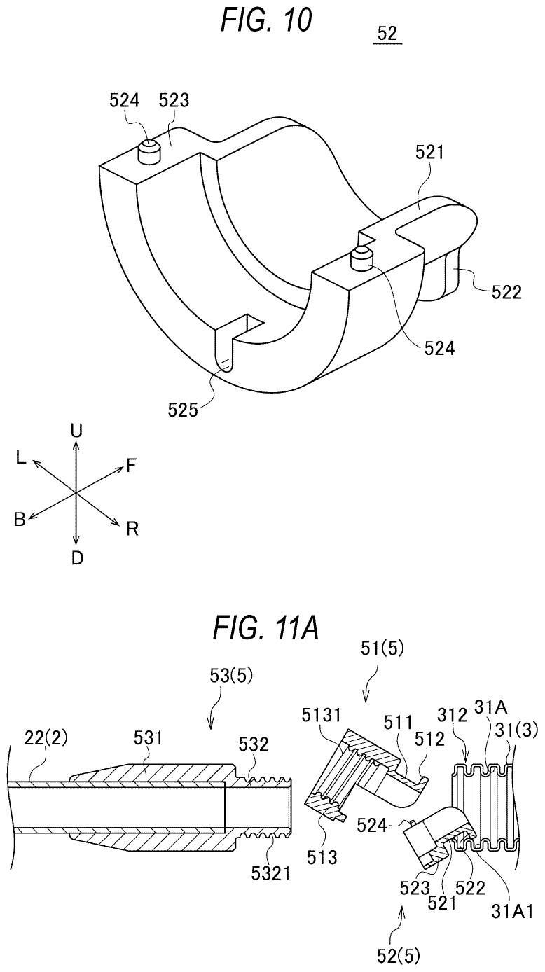

FIG. 10 illustrates the second front connection portion 52. As illustrated in FIG. 10, the second front connection portion 52 includes a second insertion portion 521 and a second protruding portion 522. The second insertion portion 521 is configured to be inserted into the protective tube 3. In the present example, the second insertion portion 521 has a semi-cylindrical shape extending along the longitudinal direction of the protective tube 3. The second protruding portion 522 is configured to be engaged with the recess 31A1 (see FIG. 2) on the inner surface 31A of the protective tube 3. In the present example, the second protruding portion 522 extends from a front end of the second insertion portion 521 along the surface orthogonal to the longitudinal direction of the protective tube 3.

The second front connection portion 52 includes a second fixing portion 523. The second front connection portion 52 is fixed to the first front connection portion 51 by the second fixing portion 523. In the present example, the second fixing portion 523 has a semi-cylindrical shape having an outer diameter larger than an outer diameter of the second insertion portion 521, and extends from a rear end of the second insertion portion 521 along the longitudinal direction of the protective tube 3.

The second front connection portion 52 includes a second protrusion 524 and a second positioning groove 525. The second protrusion 524 extends in a direction facing the first front connection portion 51. The second positioning groove 525 extends along the longitudinal direction of the protective tube 3. The second protrusion 524 is inserted into the first positioning recess 515 of the first front connection portion 51. The first protrusion 514 of the first front connection portion 51 is inserted into the second positioning groove 525. Accordingly, the second front connection portion 52 is positioned with respect to the first front connection portion 51.

Returning to FIG. 7, the rear connection portion 53 includes a cable fixing portion 531. The cable fixing portion 531 is configured to be fixed to the sheath 22 of the optical cable 2. In the present example, the cable fixing portion 531 has a cylindrical shape, and the optical cable 2 including the sheath 22 is inserted therein. The cable fixing portion 531 is fixed to the sheath 22 of the optical cable 2 by, for example, an adhesive.

The rear connection portion 53 includes a connection portion fixing portion 532. The rear connection portion 53 is fixed to the first front connection portion 51 by the connection portion fixing portion 532. In the present example, the connection portion fixing portion 532 has a cylindrical shape, and the optical fibers 21 exposed from the sheath 22 are inserted therein. In the present example, the connection portion fixing portion 532 has an outer diameter smaller than an outer diameter of the first fixing portion 513 of the first front connection portion 51, and the first fixing portion 513 is fixed to the outside of the connection portion fixing portion 532. The connection portion fixing portion 532 is formed with, on an outer peripheral surface thereof, a male screw portion 5321 that is screwed with the female screw portion 5131 formed on the inner peripheral surface of the first fixing portion 513 of the first front connection portion 51. The connection portion fixing portion 532 is an example of a third fixing portion.

### (Connection Method of Optical Cable 2 and Protective Tube 3)

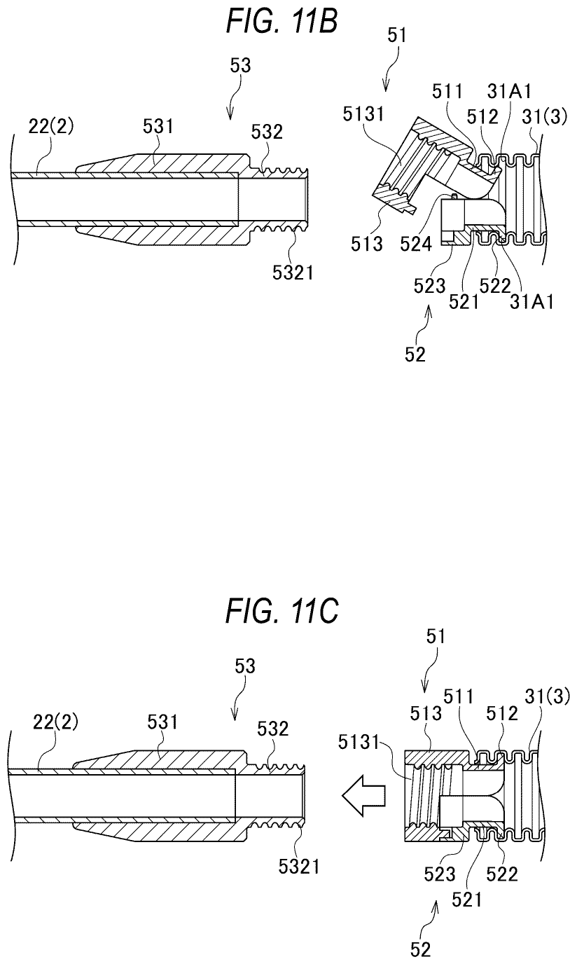

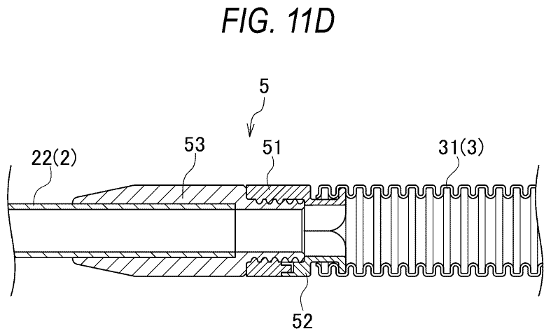

Next, a connection method of the optical cable 2 and the protective tube 3 by the connection member 5 will be described with reference to FIGS. 11A to 11D. In FIGS. 11A to 11D, the optical fibers 21 and the connectors 23 of the optical cable 2 are not illustrated.

First, the optical cable 2 subjected to a termination processing is prepared, and the rear connection portion 53 is attached to the sheath 22 of the optical cable 2 subjected to a termination processing. Specifically, the optical cable 2 subjected to a termination processing is passed through the rear connection portion 53. Then, as illustrated in FIG. 11A, the cable fixing portion 531 of the rear connection portion 53 is fixed to the sheath 22 of the optical cable 2 by an adhesive (not illustrated) in a state in which the optical fibers 21 exposed from the sheath 22 and the connectors 23 extend from a front end of the rear connection portion 53.

Subsequently, the second front connection portion 52 is attached to the protective tube 3. Specifically, as illustrated in FIG. 11A, the second insertion portion 521 and the second protruding portion 522 of the second front connection portion 52 are inserted into the rear end portion 312 of the protective tube 3, and the second protruding portion 522 is hooked and engaged with the recess 31A1 on the inner surface 31A of the rear end portion 312 of the protective tube 3 (see FIG. 11B).

Subsequently, the first front connection portion 51 is attached to the protective tube 3. Specifically, as illustrated in FIG. 11B, the first insertion portion 511 and the first protruding portion 512 of the first front connection portion 51 are inserted into the rear end portion 312 of the protective tube 3, and the first protruding portion 512 is hooked and engaged with the recess 31A1 on the inner surface 31A of the rear end portion 312 of the protective tube 3 (see FIG. 11C).

Then, the second protrusion 524 of the second front connection portion 52 is inserted into the first positioning recess 515 of the first front connection portion 51, and the first protrusion 514 of the first front connection portion 51 is inserted into the second positioning groove 525 of the second front connection portion 52. Accordingly, the second front connection portion 52 is positioned with respect to the first front connection portion 51.

Subsequently, the first front connection portion 51 and the second front connection portion 52 are fixed to the rear connection portion 53. Specifically, the optical fibers 21 exposed from the sheath 22 and the connectors 23 are inserted into the protective tube 3 through the inside of the first front connection portion 51 and the second front connection portion 52. Then, the first front connection portion 51 and the second front connection portion 52 are moved in a direction of an arrow illustrated in FIG. 11C, and the female screw portion 5131 of the first fixing portion 513 of the first front connection portion 51 is screwed onto the male screw portion 5321 of the connection portion fixing portion 532 of the rear connection portion 53 while the first front connection portion 51 and the second front connection portion 52 are rotated in a direction of an arrow illustrated in FIG. 7 with respect to the rear connection portion 53. Accordingly, as illustrated in FIG. 11D, the optical cable 2 and the protective tube 3 are connected by the connection member 5.

According to the optical cable member 10 according to the second embodiment of the present disclosure, the first front connection portion 51, the second front connection portion 52, and the rear connection portion 53 can be detachably fixed without a tool by rotating the first front connection portion 51 and the second front connection portion 52 with respect to the rear connection portion 53.

In the present embodiment, the first front connection portion 51 provided with the female screw portion 5131 is located on an upper side, and the second front connection portion 52 is located on a lower side. However, for example, the first front connection portion 51 may be located on the lower side, and the second front connection portion 52 may be located on the upper side.

In the present embodiment, each of the first front connection portion 51 and the second front connection portion 52 may include a fixing portion formed with the female screw portion on an inner peripheral surface thereof. For example, each of the first front connection portion 51 and the second front connection portion 52 may include a semi-cylindrical fixing portion formed with a groove on the inner peripheral surface thereof, and the female screw portion may be formed by coupling the grooves of the two fixing portions.

In the present embodiment, the first front connection portion 51 and the second front connection portion 52 may be fixed to each other by an adhesive.

In the present embodiment, a portion of the connection member 5 attached to the protective tube 3 is formed by two members (the first front connection portion 51 and the second front connection portion 52), but may be formed by three or more members.

### Third Embodiment

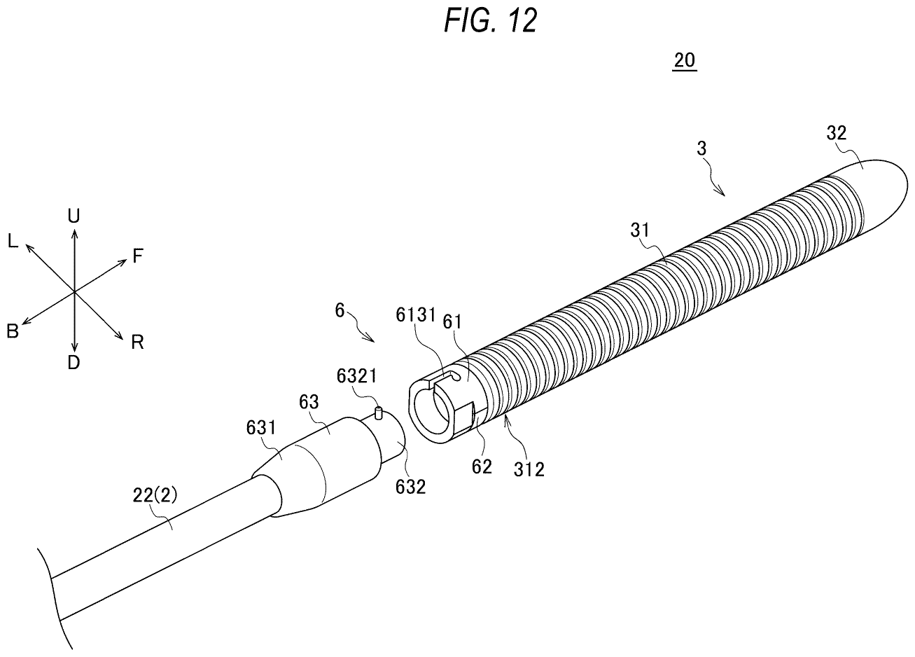

FIG. 12 illustrates a configuration example of an optical cable member 20 according to a third embodiment of the present disclosure. Members having the same reference numerals as those members already described in the description of the first embodiment and the second embodiment will not be described for convenience of description.

The optical cable member 20 according to the third embodiment of the present disclosure is different from the optical cable member 10 according to the second embodiment in a structure for fixing a first front connection portion 61 and a second front connection portion 62 to a rear connection portion 63.

Specifically, as illustrated in FIG. 12, the optical cable member 20 includes a connection member 6 that connects the optical cable 2 and the protective tube 3. The connection member 6 is formed of metal or resin. The connection member 6 includes the first front connection portion 61, the second front connection portion 62, and the rear connection portion 63. The first front connection portion 61 and the second front connection portion 62 are attached to the rear end portion 312 of the body portion 31 of the protective tube 3, respectively. The rear connection portion 63 is attached to the sheath 22 of the optical cable 2. The rear connection portion 63 is fixed to the first front connection portion 61. The first front connection portion 61 is an example of a first member. The second front connection portion 62 is an example of a second member. The rear connection portion 63 is an example of a third member.

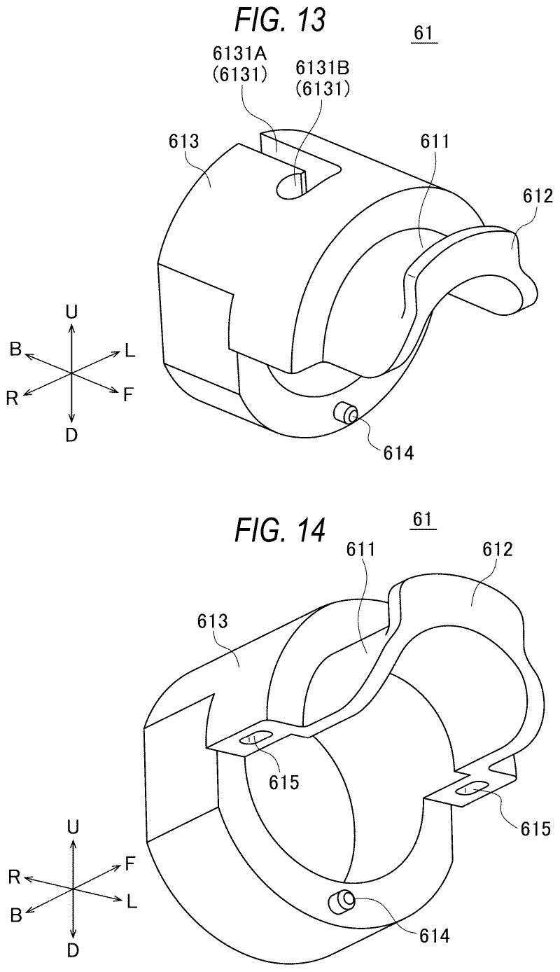

FIGS. 13 and 14 illustrate the first front connection portion 61. As illustrated in FIGS. 13 and 14, the first front connection portion 61 includes a first insertion portion 611 and a first protruding portion 612. The first insertion portion 611 is inserted into the rear end portion 312 of the protective tube 3. In the present example, the first insertion portion 611 has a semi-cylindrical shape extending along the longitudinal direction of the protective tube 3. The first protruding portion 612 is engaged with the recess 31A1 (see FIG. 2) on the inner surface 31A of the protective tube 3. In the present example, the first protruding portion 612 extends from a front end of the first insertion portion 611 along the surface orthogonal to the longitudinal direction of the protective tube 3.

The first front connection portion 61 includes a first fixing portion 613. The first front connection portion 61 is fixed to the rear connection portion 63 by the first fixing portion 613. In the present example, the first fixing portion 613 has a cylindrical shape having an outer diameter larger than an outer diameter of the first insertion portion 611, and extends from a rear end of the first insertion portion 611 along the longitudinal direction of the protective tube 3. The first fixing portion 613 is formed with an L-shaped hole 6131. Specifically, the L-shaped hole 6131 penetrates the first fixing portion 613 in a radial direction of the optical cable 2, and includes a first hole portion 6131A and a second hole portion 6131B. The first hole portion 6131A extends from a rear end of the first fixing portion 613 in the longitudinal direction of the optical cable 2. The second hole portion 6131B extends from a front end of the first hole portion 6131A in a direction orthogonal to an extending direction of the first hole portion 6131A and the radial direction of the optical cable 2.

The first front connection portion 61 includes a first protrusion 614 and a first positioning recess 615. The first protrusion 614 extends along the longitudinal direction of the protective tube 3. The first positioning recess 615 is recessed in a direction facing the second front connection portion 62.

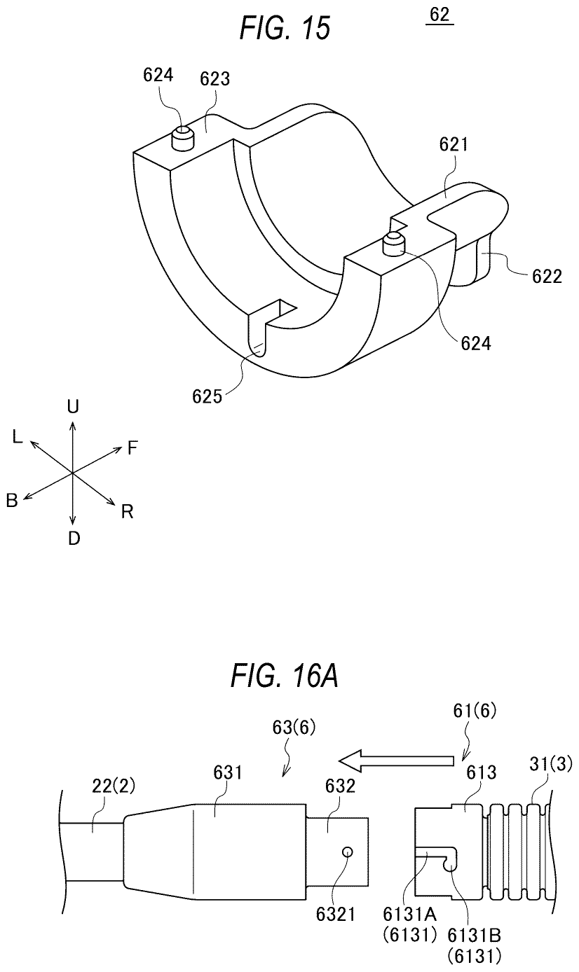

FIG. 15 illustrates the second front connection portion 62. As illustrated in FIG. 15, the second front connection portion 62 includes a second insertion portion 621 and a second protruding portion 622. The second insertion portion 621 is inserted into the protective tube 3. In the present example, the second insertion portion 621 has a semi-cylindrical shape extending along the longitudinal direction of the protective tube 3. The second protruding portion 622 is engaged with the recess 31A1 (see FIG. 2) on the inner surface 31A of the protective tube 3. In the present example, the second protruding portion 622 extends from a front end of the second insertion portion 621 along the surface orthogonal to the longitudinal direction of the protective tube 3.

The second front connection portion 62 includes a second fixing portion 623. The second front connection portion 62 is fixed to the first front connection portion 61 by the second fixing portion 623. In the present example, the second fixing portion 623 has a semi-cylindrical shape having an outer diameter larger than an outer diameter of the second insertion portion 621, and extends from a rear end of the second insertion portion 621 along the longitudinal direction of the protective tube 3.

The second front connection portion 62 includes a second protrusion 624 and a second positioning groove 625. The second protrusion 624 extends in a direction facing the first front connection portion 61. The second positioning groove 625 extends along the longitudinal direction of the protective tube 3. The second protrusion 624 is inserted into the first positioning recess 615 of the first front connection portion 51. The first protrusion 614 of the first front connection portion 61 is inserted into the second positioning groove 625. Accordingly, the second front connection portion 62 is positioned with respect to the first front connection portion 61.

Returning to FIG. 12, the rear connection portion 63 includes a cable fixing portion 631. The cable fixing portion 631 is fixed to the sheath 22 of the optical cable 2. In the present example, the cable fixing portion 631 has a cylindrical shape, and the optical cable 2 including the sheath 22 is inserted therein. The cable fixing portion 631 is fixed to the sheath 22 of the optical cable 2 by, for example, an adhesive.

The rear connection portion 63 includes a connection portion fixing portion 632. The rear connection portion 63 is fixed to the first front connection portion 61 by the connection portion fixing portion 632. In the present example, the connection portion fixing portion 632 has a cylindrical shape, and the optical fibers 21 exposed from the sheath 22 are inserted therein. In the present example, the connection portion fixing portion 632 has an outer diameter smaller than an outer diameter of the first fixing portion 613 of the first front connection portion 61, and the first fixing portion 613 is fixed to the outside of the connection portion fixing portion 632. The connection portion fixing portion 632 includes a protrusion portion 6321 that is engaged with the L-shaped hole 6131. The protrusion portion 6321 extends in the radial direction of the optical cable 2 on an outer peripheral surface of the connection portion fixing portion 632.

### (Connection Method of Optical Cable 2 and Protective Tube 3)

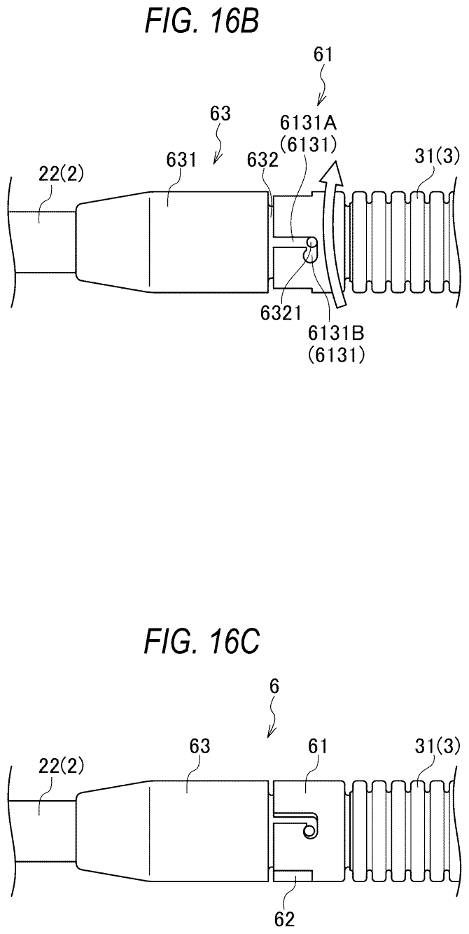

Next, a connection method of the optical cable 2 and the protective tube 3 by the connection member 6 will be described with reference to FIGS. 16A to 16C. In FIGS. 16A to 16C, the optical fibers 21 and the connectors 23 of the optical cable 2 are not illustrated.

First, as illustrated in FIG. 16A, the rear connection portion 63 is fixed to the sheath 22 of the optical cable 2. In addition, the first front connection portion 61 and the second front connection portion 62 are attached to the protective tube 3. A method of fixing the rear connection portion 63 to the sheath 22 of the optical cable 2 and a method of attaching the first front connection portion 61 and the second front connection portion 62 to the protective tube 3 are the same as those in the second embodiment, and thus the description and illustration thereof will be omitted.

Subsequently, the first front connection portion 61 and the second front connection portion 62 are fixed to the rear connection portion 63. Specifically, the first front connection portion 61 and the second front connection portion 62 are moved in a direction of an arrow illustrated in FIG. 16A, and the protrusion portion 6321 of the connection portion fixing portion 632 of the second front connection portion 62 is inserted into the first hole portion 6131A of the L-shaped hole 6131 of the first fixing portion 613 of the first front connection portion 61. Then, the first front connection portion 61 and the second front connection portion 62 are slid in a direction along the longitudinal direction with respect to the rear connection portion 63 while guiding the protrusion portion 6321 in the first hole portion 6131A of the L-shaped hole 6131.

Subsequently, when the protrusion portion 6321 moves to the front end of the first hole portion 6131A of the L-shaped hole 6131, the first front connection portion 61 and the second front connection portion 62 are rotated in a direction (direction of an arrow illustrated in FIG. 16B) orthogonal to the longitudinal direction with respect to the rear connection portion 63, and the protrusion portion 6321 is inserted into the second hole portion 6131B of the L-shaped hole 6131. The first front connection portion 61 and the second front connection portion 62 are rotated while guiding the protrusion portion 6321 in the second hole portion 6131B of the L-shaped hole 6131 until the protrusion portion 6321 moves to an end of the second hole portion 6131B of the L-shaped hole 6131. Accordingly, as illustrated in FIG. 16C, the optical cable 2 and the protective tube 3 are connected by the connection member 6.

In the optical cable member 20 according to the third embodiment of the present disclosure, the first front connection portion 61 and the second front connection portion 62 of the connection member 6 are bayonet-fixed to the rear connection portion 63. That is, by sliding and rotating the first front connection portion 61 and the second front connection portion 62 with respect to the rear connection portion 63, the first front connection portion 61, the second front connection portion 62, and the rear connection portion 63 can be detachably fixed without a tool.

In the present embodiment, the first front connection portion 61 formed with the L-shaped hole 6131 is located on an upper side, and the second front connection portion 62 is located on a lower side. However, for example, the first front connection portion 61 may be located on the lower side, and the second front connection portion 62 may be located on the upper side.

In the present embodiment, each of the first front connection portion 61 and the second front connection portion 62 may include, for example, a semi-cylindrical fixing portion.

In the present embodiment, the first front connection portion 61 and the second front connection portion 62 may be fixed to each other by an adhesive.

In the present embodiment, a portion of the connection member 6 attached to the protective tube 3 is formed by two members (the first front connection portion 61 and the second front connection portion 62), but may be formed by three or more members.

### (Modification 1)

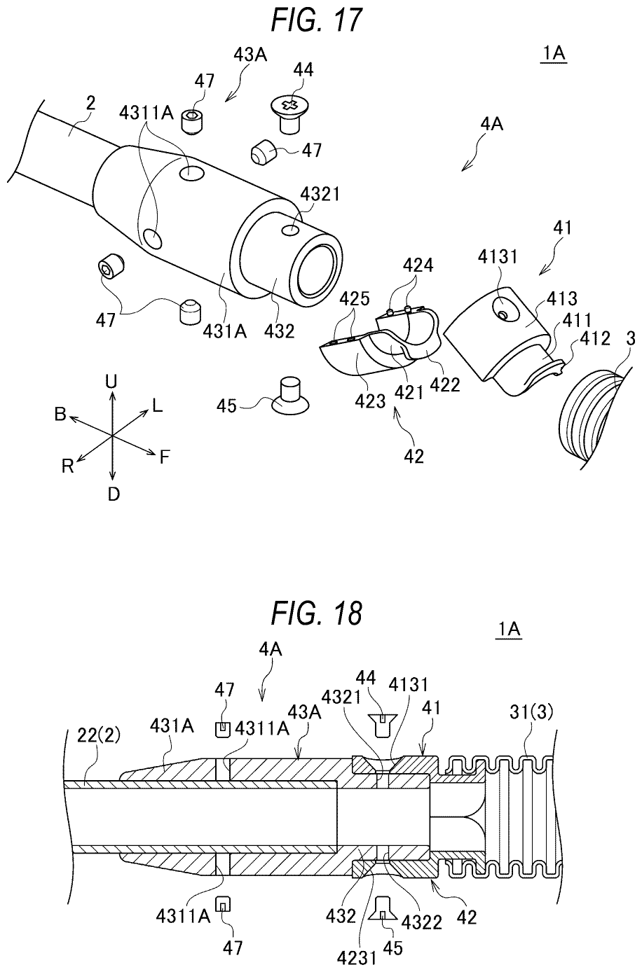

FIGS. 17 and 18 illustrate Modification 1 of the optical cable member 1 according to the first embodiment. Members or portions having the same shapes as the members or portions of the first embodiment are denoted by the same reference numerals, and description thereof will be omitted for convenience of description.

An optical cable member 1A according to Modification 1 is different from the optical cable member 1 according to the first embodiment in a structure of a rear connection portion 43A of a connection member 4A.

As illustrated in FIGS. 17 and 18, the rear connection portion 43A according to Modification 1 includes a cable fixing portion 431A and a connection portion fixing portion 432. The cable fixing portion 431A is formed with a plurality of through holes 4311A penetrating the cable fixing portion 431A. In the present example, each of the plurality of through holes 4311A extends in the radial direction of the optical cable 2. The through hole 4311A is an example of a fifth hole.

The connection member 4A includes a plurality of screw members 47 corresponding to the number of the plurality of through holes 4311A. The plurality of screw members 47 are inserted into the corresponding through holes 4311A and brought into contact with the sheath 22 of the optical cable 2, so that the cable fixing portion 431A of the rear connection portion 43A can be fixed to the sheath 22 of the optical cable 2.

According to the optical cable member 1A of Modification 1, the rear connection portion 43A can be detachably fixed to the sheath 22 of the optical cable 2 by the screw members 47.

In the present modification, the cable fixing portion 431A of the rear connection portion 43A may be further fixed to the sheath 22 of the optical cable 2 by an adhesive.

The present modification can also be applied to the second embodiment and the third embodiment. Specifically, the rear connection portion 53 of the optical cable member 10 according to the second embodiment or the rear connection portion 63 of the optical cable member 20 according to the third embodiment may be similarly attached to the sheath 22 of the optical cable 2 using a screw member.

### (Modification 2)

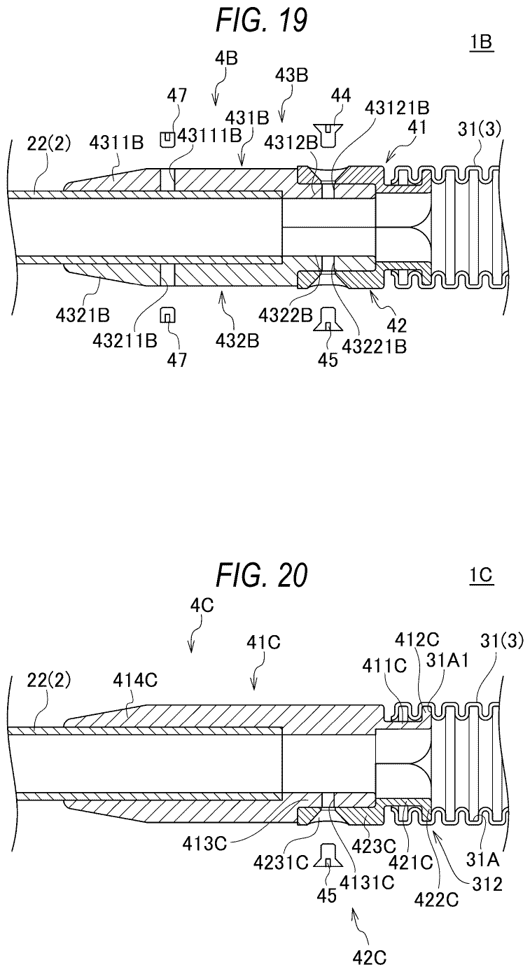

FIG. 19 illustrates Modification 2 of the optical cable member 1 according to the first embodiment. Members or portions having the same shapes as the members or portions of the first embodiment are denoted by the same reference numerals, and description thereof will be omitted for convenience of description.

An optical cable member 1B according to Modification 2 is different from the optical cable member 1 according to the first embodiment in a structure of a rear connection portion 43B of a connection member 4B.

As illustrated in FIG. 19, the rear connection portion 43B according to Modification 2 includes a first portion 431B and a second portion 432B that can be divided in the radial direction of the optical cable 2. The first portion 431B includes a cable fixing portion 4311B and a connection portion fixing portion 4312B. The cable fixing portion 4311B is fixed to the sheath 22 of the optical cable 2. Specifically, the cable fixing portion 4311B is formed with a through hole 43111B into which the screw member 47 is inserted. The connection portion fixing portion 4312B is fixed to the first front connection portion 41. The connection portion fixing portion 4312B is formed with a through hole 43121B into which the first screw member 44 is inserted.

The second portion 432B includes a cable fixing portion 4321B and a connection portion fixing portion 4322B. The cable fixing portion 4321B is fixed to the sheath 22 of the optical cable 2. The cable fixing portion 4321B is formed with a through hole 43211B into which the screw member 47 is inserted. The connection portion fixing portion 4322B is fixed to the second front connection portion 42. The connection portion fixing portion 4322B is formed with a through hole 43221B into which the second screw member 45 is inserted.

When the optical cable 2 and the protective tube 3 are connected by the connection member 4B configured as described above, the first front connection portion 41 and the second front connection portion 42 are attached to the protective tube 3, respectively.

The first portion 431B and the second portion 432B of the rear connection portion 43B are attached to the optical cable 2, respectively. Specifically, the cable fixing portion 4311B of the first portion 431B is disposed outside the sheath 22 of the optical cable 2, the screw member 47 is inserted into the through hole 43111B, and the cable fixing portion 4311B is fixed to the sheath 22 by the screw member 47. In addition, the cable fixing portion 4321B of the second portion 432B is disposed outside the sheath 22 of the optical cable 2, the screw member 47 is inserted into the through hole 43211B, and the cable fixing portion 4321B is fixed to the sheath 22 by the screw member 47.

Subsequently, the first front connection portion 41 and the second front connection portion 42 are fixed to the first portion 431B and the second portion 432B of the rear connection portion 43B by the first screw member 44 and the second screw member 45. Accordingly, the optical cable 2 and the protective tube 3 are connected by the connection member 4B.

Here, when the rear connection portion 43 has a cylindrical shape as in the rear connection portion 43 according to the first embodiment, it is necessary to fix the rear connection portion 43 to the optical cable 2 after the termination processing of the optical cable 2 is performed and before the optical fibers 21 and the connectors 23 of the optical cable 2 are inserted into the protective tube 3. However, according to the optical cable member 1B of Modification 2, the rear connection portion 43B can be divided in the radial direction of the optical cable 2, and thus the rear connection portion 43B can also be fixed to the optical cable 2 after the optical fibers 21 and the connectors 23 of the optical cable 2 are inserted into the protective tube 3. Accordingly, a degree of freedom of the attachment workability of the rear connection portion 43B is increased.

In the present modification, the rear connection portion 43 is formed by two members (the first portion 431B and the second portion 432B), but may be formed by three or more members.

In the present modification, the cable fixing portion 4311B and the cable fixing portion 4321B may be fixed to the sheath 22 of the optical cable 2 by an adhesive.

The present modification can also be applied to the second embodiment and the third embodiment. Specifically, the rear connection portion 53 of the optical cable member 10 according to the second embodiment and the rear connection portion 63 of the optical cable member 20 according to the third embodiment may similarly include a first portion and a second portion that can be divided in the radial direction of the optical cable 2.

### (Modification 3)

FIG. 20 illustrates Modification 3 of the optical cable member 1 according to the first embodiment. Members or portions having the same shapes as the members or portions of the first embodiment are denoted by the same reference numerals, and description thereof will be omitted for convenience of description.

An optical cable member 1C according to Modification 3 is different from the optical cable member 1 according to the first embodiment in a structure of a connection member 4C.

As illustrated in FIG. 20, the connection member 4C according to Modification 3 includes a first member 41C and a second member 42C. The first member 41C is attached to the optical cable 2 and the protective tube 3. Specifically, the first member 41C includes a first insertion portion 411C, a first protruding portion 412C, a connection portion fixing portion 413C, and a cable fixing portion 414C. The first insertion portion 411C is inserted into the protective tube 3. The first protruding portion 412C is engaged with the recess 31A1 on the inner surface 31A of the protective tube 3. The connection portion fixing portion 413C is fixed to the second member 42C. The connection portion fixing portion 413C is formed with a through hole 4131C into which the second screw member 45 is inserted. The cable fixing portion 414C is fixed to the sheath 22 of the optical cable 2 by, for example, an adhesive.

The second member 42C is attached to the protective tube 3. Specifically, the second member 42C includes a second insertion portion 421C, a second protruding portion 422C, and a connection portion fixing portion 423C. The second insertion portion 421C is inserted into the protective tube 3. The second protruding portion 422C is engaged with the recess 31A1 on the inner surface 31A of the protective tube 3. The connection portion fixing portion 423C is fixed to the first member 41C. The connection portion fixing portion 423C is formed with a through hole 4231C into which the second screw member 45 is inserted.

When the optical cable 2 and the protective tube 3 are connected by the connection member 4C configured as described above, first, the first member 41C is fixed to the sheath 22 of the optical cable 2 and the protective tube 3. Specifically, the cable fixing portion 414C of the first member 41C is fixed to the sheath 22 of the optical cable 2 by, for example, an adhesive. Subsequently, the first insertion portion 411C and the first protruding portion 412C of the first member 41C are inserted into the rear end portion 312 of the protective tube 3, and the first protruding portion 412C is hooked and engaged with the recess 31A1 on the inner surface 31A of the rear end portion 312 of the protective tube 3.

Subsequently, the second member 42C is attached to the protective tube 3. Specifically, the second insertion portion 421C and the second protruding portion 422C of the second member 42C are inserted into the rear end portion 312 of the protective tube 3, and the second protruding portion 422C is hooked and engaged with the recess 31A1 on the inner surface 31A of the rear end portion 312 of the protective tube 3.

Subsequently, the first member 41C and the second member 42C are fixed to each other. Specifically, the first member 41C and the second member 42C are fixed by inserting the second screw member 45 into the through hole 4231C of the second member 42C and the through hole 4131C of the first member 41C. Accordingly, the optical cable 2 and the protective tube 3 are connected by the connection member 4C.

According to the optical cable member 1C of Modification 3, the first member 41C includes a portion attached to the protective tube 3 and a portion attached to the optical cable 2, and thus the number of components constituting the connection member 4C and the number of connection steps can be reduced.

In the present modification, the cable fixing portion 414C may be fixed to the sheath 22 of the optical cable 2 by forming a through hole in the cable fixing portion 414C and inserting a screw member into the through hole.

### (Modification 4)

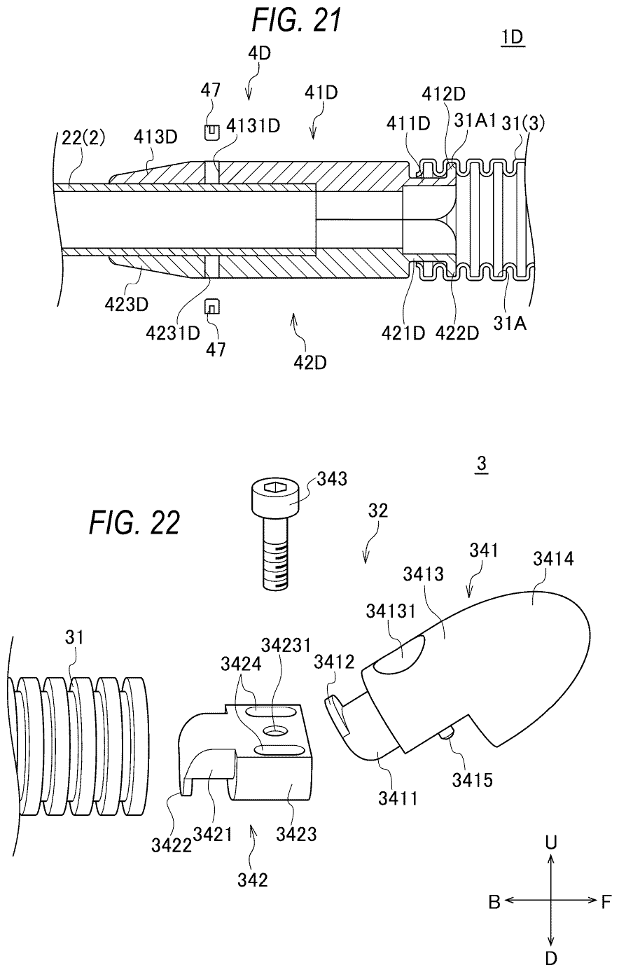

FIG. 21 illustrates Modification 4 of an optical cable member 1B according to Modification 2. Members or portions having the same shapes as the members or portions of Modification 2 are denoted by the same reference numerals, and description thereof will be omitted for convenience of description.

An optical cable member 1D according to Modification 4 is different from the optical cable member 1B according to Modification 2 in a structure of a connection member 4D.

As illustrated in FIG. 21, the connection member 4D according to Modification 4 includes a first member 41D and a second member 42D that can be divided in the radial direction of the optical cable 2. The first member 41D is attached to the optical cable 2 and the protective tube 3. Specifically, the first member 41D includes a first insertion portion 411D, a first protruding portion 412D, and a cable fixing portion 413D. The first insertion portion 411D is inserted into the protective tube 3. The first protruding portion 412D is engaged with the recess 31A1 on the inner surface 31A of the protective tube 3. The cable fixing portion 413D is fixed to the sheath 22 of the optical cable 2. The cable fixing portion 413D is formed with a through hole 4131D into which the screw member 47 is inserted.

The second member 42D is attached to the optical cable 2 and the protective tube 3. Specifically, the second member 42D includes a second insertion portion 421D, a second protruding portion 422D, and a cable fixing portion 423D. The second insertion portion 421D is inserted into the protective tube 3. The second protruding portion 422D is engaged with the recess 31A1 on the inner surface 31A of the protective tube 3. The cable fixing portion 423D is fixed to the sheath 22 of the optical cable 2. The cable fixing portion 423D is formed with a through hole 4231D into which the screw member 47 is inserted.

When the optical cable 2 and the protective tube 3 are connected by the connection member 4D configured as described above, first, the first member 41D and the second member 42D are attached to the protective tube 3, respectively. Specifically, the first insertion portion 411D and the first protruding portion 412D of the first member 41D are inserted into the rear end portion 312 of the protective tube 3, and the first protruding portion 412D is hooked and engaged with the recess 31A1 on the inner surface 31A of the rear end portion 312 of the protective tube 3. In addition, the second insertion portion 421D and the second protruding portion 422D of the second member 42D are inserted into the rear end portion 312 of the protective tube 3, and the second protruding portion 422D is hooked and engaged with the recess 31A1 on the inner surface 31A of the rear end portion 312 of the protective tube 3.

Subsequently, the first member 41D and the second member 42D are attached to the optical cable 2, respectively. Specifically, the cable fixing portion 413D of the first member 41D is disposed outside the sheath 22 of the optical cable 2, the screw member 47 is inserted into the through hole 4131D, and the cable fixing portion 413D is fixed to the sheath 22 by the screw member 47. In addition, the cable fixing portion 423D of the second member 42D is disposed outside the sheath 22 of the optical cable 2, the screw member 47 is inserted into the through hole 4231D, and the cable fixing portion 423D is fixed to the sheath 22 by the screw member 47. Accordingly, the optical cable 2 and the protective tube 3 are connected by the connection member 4D.

According to the optical cable member 1D of Modification 4, the first member 41D and the second member 42D each include a portion attached to the protective tube 3 and a portion attached to the optical cable 2, and thus the number of components constituting the connection member 4D and the number of connection steps can be reduced.

In the present modification, the connection member 4D is formed by two members (the first member 41D and the second member 42D), but may be formed by three or more members.

In the present modification, the cable fixing portion 413D and the cable fixing portion 423D may be fixed to the sheath 22 of the optical cable 2 by an adhesive.

### (Protective Tube)

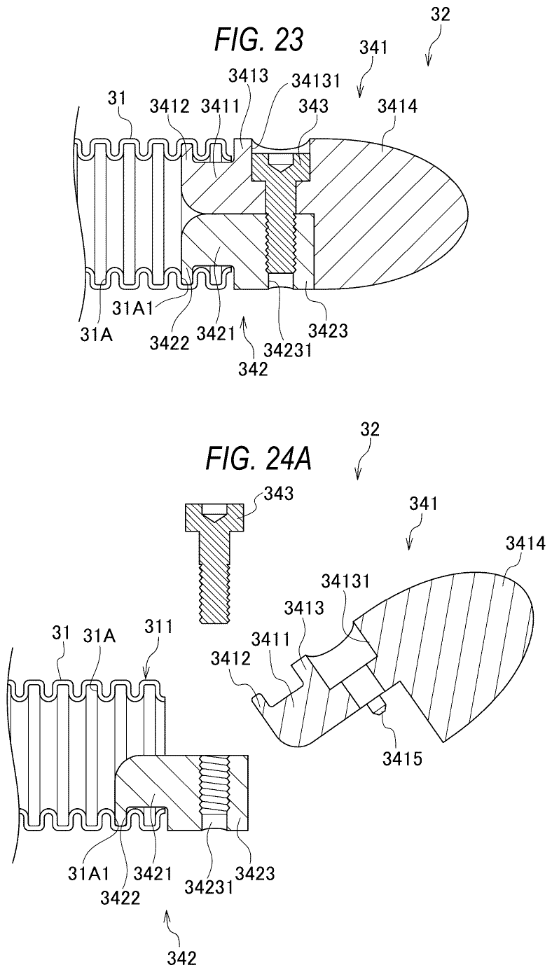

Next, the configuration of the protective tube 3 will be described with reference to FIGS. 22 and 23. FIG. 22 is an exploded view illustrating a configuration of the lid portion 32 of the protective tube 3. FIG. 23 is a cross-sectional view of the protective tube 3 of FIG. 22.

As illustrated in FIG. 22, the protective tube 3 is configured such that the lid portion 32 is detachable from the body portion 31. The lid portion 32 includes a first member 341 and a second member 342. The first member 341 includes a first insertion portion 3411, a first protruding portion 3412, a first fixing portion 3413, a tip portion 3414, and a first positioning portion 3415. The first insertion portion 3411 is inserted into the protective tube 3. In the present example, the first insertion portion 3411 extends along the longitudinal direction of the protective tube 3. The first protruding portion 3412 is engaged with the recess 31A1 on the inner surface 31A of the protective tube 3. In the present example, the first protruding portion 3412 extends from a rear end of the first insertion portion 3411 along the surface orthogonal to the longitudinal direction of the protective tube 3. The first fixing portion 3413 is fixed to the second member 342. In addition, the first fixing portion 3413 is formed with a first through hole 34131 penetrating the first fixing portion 3413. The first through hole 34131 extends in a direction facing the second member 342. The tip portion 3414 has a curved shape such as a sphere, a half football, or a bell shape, and has an outer diameter equal to or smaller than the outer diameter of the body portion 31, for example. The first positioning portion 3415 is used to position the first member 341 with respect to the second member 342. In the present example, the first positioning portion 3415 is a protrusion.

The second member 342 includes a second insertion portion 3421, a second protruding portion 3422, a second fixing portion 3423, and a second positioning portion 3424. The second insertion portion 3421 is inserted into the protective tube 3. In the present example, the second insertion portion 3421 extends along the longitudinal direction of the protective tube 3. The second protruding portion 3422 is engaged with the recess 31A1 on the inner surface 31A of the protective tube 3. In the present example, the second protruding portion 3422 extends from a rear end of the second insertion portion 3421 along the surface orthogonal to the longitudinal direction of the protective tube 3. The second fixing portion 3423 is fixed to the first member 341. In addition, the second fixing portion 3423 is formed with a second through hole 34231 penetrating the second fixing portion 3423 at a position corresponding to the first through hole 34131. The second through hole 34231 extends in a direction facing the first member 341. The second positioning portion 3424 is used to position the second member 342 with respect to the first member 341. In the present example, the second positioning portion 3424 is a recess.

In the present example, the first insertion portion 3411 and the first protruding portion 3412 of the first member 341 and the second insertion portion 3421 and the second protruding portion 3422 of the second member 342 form the attachment portion 322 in FIG. 2. The first fixing portion 3413 and the tip portion 3414 of the first member 341 and the second fixing portion 3423 of the second member 342 form the tip portion 321 in FIG. 2.

The lid portion 32 further includes a screw member 343. The screw member 343 is inserted into the first through hole 34131 and the second through hole 34231 in a state in which the first fixing portion 3413 of the first member 341 and the second fixing portion 3423 of the second member 342 overlap each other. Accordingly, the first member 341 and the second member 342 are fixed to each other.

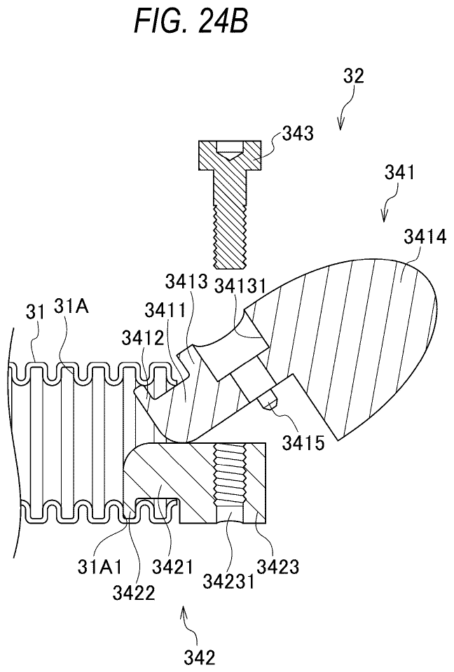

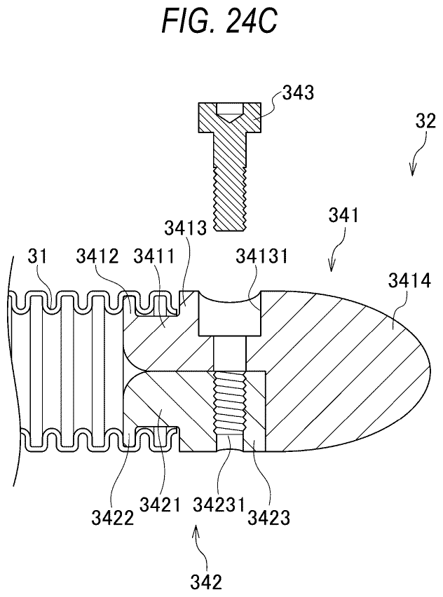

Next, a method of attaching the lid portion 32 to the body portion 31 will be described with reference to FIGS. 24A to 24C.

First, the second member 342 is attached to the body portion 31. Specifically, as illustrated in FIG. 24A, the second insertion portion 3421 and the second protruding portion 3422 of the second member 342 are inserted into the front end portion 311 of the body portion 31, and the second protruding portion 3422 is hooked and engaged with the recess 31A1 on the inner surface 31A of the front end portion 311 of the body portion 31 (see FIG. 24B).

Subsequently, the first member 341 is fixed to the body portion 31. Specifically, as illustrated in FIG. 24B, the first insertion portion 3411 and the first protruding portion 3412 of the first member 341 are inserted into the front end portion 311 of the body portion 31, and the first protruding portion 3412 is hooked and engaged with the recess 31A1 on the inner surface 31A of the front end portion 311 of the body portion 31 (see FIG. 24C). Then, the first member 341 and the second member 342 are positioned by the first positioning portion 3415 of the first member 341 and the second positioning portion 3424 of the second member 342.

Subsequently, as illustrated in FIG. 24C, the first member 341 and the second member 342 are fixed to each other. Specifically, the screw member 343 is inserted into the first through hole 34131 of the first member 341 and the second through hole 34231 of the second member 342. Accordingly, as illustrated in FIG. 23, the lid portion 32 is attached to the body portion 31.

In this way, the lid portion 32 is detachable from the body portion 31.

In the present example, the first member 341 including the tip portion 3414 is located on an upper side, and the second member 342 is located on a lower side. However, for example, the first member 341 may be located on the lower side, and the second member 342 may be located on the upper side.

In the present example, each of the first member 341 and the second member 342 may include a tip portion. For example, each of the first member 341 and the second member 342 may include a hemispherical tip portion.

In the present example, the lid portion 32 is formed by two members (the first member 341 and the second member 342), but may be formed by three or more members.

Although the present invention is described in detail and with reference to a specific embodiment, it will be apparent to those skilled in the art that various changes and modifications can be made therein without departing from the spirit and scope of the present invention. Furthermore, the numbers, positions, shapes, and the like of the members described above are not limited to the above embodiment, and may be changed to any number, position, shape, and the like that is suitable for implementing the present invention.

In the above embodiments and modifications, the body portion 31 of the protective tube 3 is formed in a bellows shape over the entire length in the longitudinal direction. However, in the body portion 31, at least the inner surface 31A of the rear end portion 312 to which the connection member 4 is connected may be formed in an uneven shape. When the lid portion 32 of the body portion 31 is formed by two members as illustrated in FIG. 22, at least the inner surface 31A of the front end portion 311 to which the lid portion 32 is connected may be formed in an uneven shape. That is, the outer surface 31B of the body portion 31 may be formed in a planar shape instead of an uneven shape. In addition, a portion of the inner surface 31A of the body portion 31, except for both end portions (the front end portion 311 and the rear end portion 312) in the longitudinal direction to which the connection member 4 and the lid portion 32 are not connected, may be formed in a planar shape instead of an uneven shape.

In the above embodiments and modifications, the connection portion fixing portion of the rear connection portion is disposed inside the first fixing portion of the first front connection portion and the second fixing portion of the second front connection portion. However, the connection portion fixing portion of the rear connection portion may be disposed outside the first fixing portion of the first front connection portion and the second fixing portion of the second front connection portion. For example, in the second embodiment, a male screw portion may be formed on the outer peripheral surface of the first fixing portion 513 of the first front connection portion 51, and a male screw portion may be formed on the inner peripheral surface of the connection portion fixing portion 532 of the rear connection portion 53. For example, in the third embodiment, a protrusion portion may be formed on the outer peripheral surface of the first fixing portion 613 of the first front connection portion 61, and an L-shaped hole may be formed in the connection portion fixing portion 632 of the rear connection portion 63.

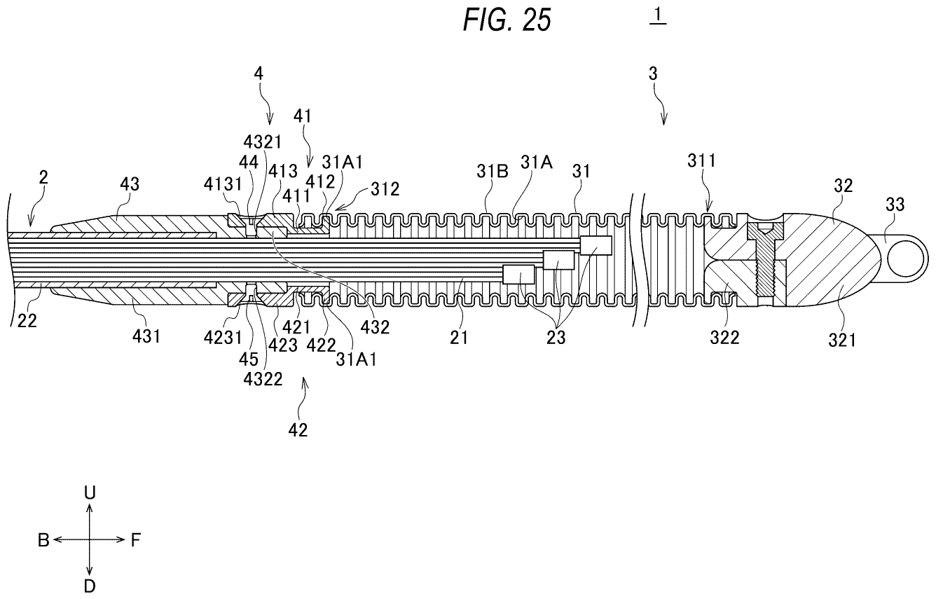

In the above embodiments and modifications, the optical cable members 1, 10, 20, and 1A to 1D are members used for laying the optical cable 2 by using the air pressure feeding method. However, the optical cable members 1, 10, 20, and 1A to 1D may be used for laying the optical cable 2 by using the cable pulling method. For example, as illustrated in FIG. 25, the protective tube 3 may include a coupling member 33 attached to the lid portion 32. A wire is coupled to the coupling member 33, and the optical cable 2 inserted into a laying tube is pulled to a predetermined position by the wire coupled to the coupling member 33.

### REFERENCE SIGNS LIST

1: optical cable member
1A: optical cable member
1B: optical cable member
1C: optical cable member
1D: optical cable member
2: optical cable
3: protective tube
4: connection member
4A: connection member
4B: connection member
4C: connection member
4D: connection member
5: connection member
6: connection member
10: optical cable member
20: optical cable member
21: optical fiber
22: sheath
23: connector
31: body portion
31A: inner surface
31A1: recess
31B: outer surface
32: lid portion
33: coupling member
41: first front connection portion
41C: first member
41D: first member
42: second front connection portion
42C: second member
42D: second member
43: rear connection portion
43A: rear connection portion
43B: rear connection portion
44: first screw member
45: second screw member
46: adhesive
47: screw member
51: first front connection portion
52: second front connection portion
53: rear connection portion
61: first front connection portion
62: second front connection portion
63: rear connection portion
311: front end portion
312: rear end portion
321: tip portion
322: attachment portion
341: first member
342: second member
343: screw member
411: first insertion portion
411C: first insertion portion
411D: first insertion portion
412: first protruding portion
412C: first protruding portion
412D: first protruding portion
413: first fixing portion
413C: connection portion fixing portion
413D: cable fixing portion
414: first protrusion
414C: cable fixing portion
415: first positioning recess
421: second insertion portion
421C: second insertion portion
421D: second insertion portion
422: second protruding portion
422C: second protruding portion
422D: second protruding portion
423: second fixing portion
423C: connection portion fixing portion
423D: cable fixing portion
424: second protrusion
425: second positioning recess
431: cable fixing portion
431A: cable fixing portion
431B: first portion
432: connection portion fixing portion
432B: second portion
511: first insertion portion
512: first protruding portion
513: first fixing portion
514: first protrusion
515: first positioning recess
521: second insertion portion
522: second protruding portion
523: second fixing portion
524: second protrusion
525: second positioning groove
531: cable fixing portion
532: connection portion fixing portion
611: first insertion portion
612: first protruding portion
613: first fixing portion
614: first protrusion
615: first positioning recess
621: second insertion portion
622: second protruding portion
623: second fixing portion
624: second protrusion
625: second positioning groove
631: cable fixing portion
632: connection portion fixing portion
3411: first insertion portion
3412: first protruding portion
3413: first fixing portion
3414: tip portion
3415: first positioning portion
3421: second insertion portion
3422: second protruding portion
3423: second fixing portion
3424: second positioning portion
4131: first through hole
4131C: through hole
4131D: through hole
4231: second through hole
4231C: through hole
4231D: through hole
4311A: through hole
4311B: cable fixing portion
4312B: connection portion fixing portion
4321: through hole
4321B: cable fixing portion
4322: through hole
4322B: connection portion fixing portion
5131: female screw portion
5321: male screw portion
6131: L-shaped hole
6131A: first hole portion
6131B: second hole portion
6321: protrusion portion
34131: first through hole
34231: second through hole
43111B: through hole
43121B: through hole
43211B: through hole
43221B: through hole

1. An optical cable member comprising:
an optical cable including a plurality of optical fibers, at least one connector attached to tips of the plurality of optical fibers, and a sheath covering the plurality of optical fibers;
a protective tube configured to accommodate the plurality of optical fibers exposed from the sheath, and the at least one connector; and
a connection member that connects the optical cable and the protective tube,
wherein the protective tube has a tube shape having an uneven first inner surface at an first end portion to which the connection member is attached, and
the connection member includes:
a first member including a first insertion portion configured to be inserted into the protective tube, and a first protruding portion configured to be engaged with a recess on the first inner surface of the protective tube; and
a second member including a second insertion portion configured to be inserted into the protective tube, and a second protruding portion configured to be engaged with the recess on the first inner surface of the protective tube.

2. The optical cable member according to claim 1,
wherein the connection member includes a third member attached to the sheath of the optical cable, and
the third member is fixed to at least the first member.

3. The optical cable member according to claim 2,
wherein the first member includes a first fixing portion fixed to the third member, and the first fixing portion is formed with a first hole penetrating the first fixing portion,
the second member includes a second fixing portion fixed to the third member, and the second fixing portion is formed with a second hole penetrating the second fixing portion,
the third member includes a third fixing portion fixed to the first member and the second member, the third fixing portion is formed with a third hole penetrating the third fixing portion at a position corresponding to the first hole, and the third fixing portion is formed with a fourth hole penetrating the third fixing portion at a position corresponding to the second hole, and
the connection member includes a first screw member configured to be inserted into the first hole and the third hole, and a second screw member configured to be inserted into the second hole and the fourth hole.

4. The optical cable member according to claim 2,
wherein the first member includes a first fixing portion configured to be fixed to the third member,
the third member includes a third fixing portion configured to be fixed to the first member,
one of the first fixing portion or the third fixing portion has an outer peripheral surface on which a male screw portion is formed, and
another of the first fixing portion or the third fixing portion, which is not formed with the male screw portion on the outer peripheral surface thereof, has an inner peripheral surface on which a female screw portion to be screwed onto the male screw portion is formed.

5. The optical cable member according to claim 2,
wherein the first member includes a first fixing portion configured to be fixed to the third member,
the third member includes a third fixing portion configured to be fixed to the first member,
one of the first fixing portion or the third fixing portion is formed with an L-shaped hole, and
another of the first fixing portion or the third fixing portion in which no L-shaped hole is formed includes a protrusion portion that is configured to be engaged with the L-shaped hole.

6. The optical cable member according to claim 2, wherein the first member and the second member are fixed to each other by an adhesive.

7. The optical cable member according to claim 2, wherein the third member is fixed to the sheath of the optical cable by an adhesive.

8. The optical cable member according to claim 2,
wherein the third member is formed with a fifth hole penetrating the third member, and
the optical cable member includes a screw member that is inserted into the fifth hole and brought into contact with the sheath of the optical cable.

9. The optical cable member according to claim 7,
wherein the third member includes a first portion and a second portion that are dividable in a radial direction of the optical cable.

10. The optical cable member according to claim 1,
wherein the protective tube includes a lid portion, and a body portion accommodating the at least one connector and the plurality of optical fibers exposed from the sheath,
the body portion includes a second end portion to which the lid portion is fixed,
the body portion has a tube shape having an uneven second inner surface at the second end portion, and
the lid portion includes:
a first member including a first insertion portion configured to be inserted into the body portion, and a first protruding portion configured to be engaged with a recess on the second inner surface of the body portion; and
a second member including a second insertion portion configured to be inserted into the body portion, and a second protruding portion configured to be engaged with the recess on the second inner surface of the body portion.
